(19) United States
(12) Patent Application Publication
(10) Pub. No.: US 2023/0413861 A1
(43) Pub. Date: Dec. 28, 2023

(54) EDIBLE PET CHEW AND METHOD FOR MAKING THE SAME

(71) Applicant: SHANGHAI SUNLIGHT INNOV TRADING CO., LTD., Shanghai (CN)

(72) Inventors: Dequan Shen, Shanghai (CN); Guangqiang Xu, Shanghai (CN)

(21) Appl. No.: 17/818,353

(22) Filed: Aug. 8, 2022

(30) Foreign Application Priority Data
Jun. 24, 2022 (CN) 202210729420.8

(51) Int. Cl. A23K 50/42; A23K 40/30; A23K 10/26; A23K 40/25; A23K 40/20; A23K 10/35

(52) U.S. Cl. CPC A23K 50/42; A23K 40/30; A23K 10/35; A23K 40/25; A23K 40/20; A23K 10/26

(57) ABSTRACT

In an aspect, an edible pet chew includes a tubular component with alternating ridges and grooves on the surface formed from for example a composite material or a rawhide sheet material. In some embodiments, the tubular component may be in a corrugated-pipe shape or trachea chew shape. In some embodiments, the tubular component is formed from a curved or rolled corrugated sheet or a curved or rolled ribbed sheet. In another aspect, an edible pet chew includes a cylinder component with alternating ridges and grooves on the surface. In another aspect, an edible pet chew includes a curved corrugated-sheet chip or curved ribbed-sheet chip component with a cross-section shape of a(n) curve/arc with alternating ridges and grooves on the surface. And methods forming the same are provided.

### CROSS-REFERENCE TO RELATED APPLICATIONS

This is a non-provisional application that claims priority to Chinese Application No. 202210729420.8, filed on Jun. 24, 2022, and entitled “EDIBLE PET CHEW”.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### FIELD OF DISCLOSURE

The field of this disclosure relates to an edible pet chew, and more particularly to an edible pet chew including a series of ridges.

### DESCRIPTION OF RELATED ARTS

Dogs as carnivorous animals, have inherent urge to chew things. Visiting to a pet store or supermarket makes it readily apparent that there is a wide selection of dog chew products created to accommodate their chewing activities. These products of this kind provide favorable benefits to dogs such as entertaining, exercising jaws, reducing plaque and tartar, freshening breathes and keeping them busy. Edible “Pet Chews” are intended to be chewed by a pet/dog for an extended period of time and then swallowed. Traditional rawhide chews and later plant-based (starch-based) chews made of (artificial) composite material such as vegetable toothbrush-shaped dental chews (under Greenies brand) were introduced to market widely welcome by dogs and their owners. It is noted that dog treats and dog chews usually refer to dry feeding stuffs (dry feed) rather than moist feed (wet treat or wet feed), with moisture content substantially less than 25%.

In the drainage pipe industry or plastic corrugated tubing (such as cable tubing) industry, some pipes or tubings have ridge textures and some others have a helix texture. These corrugated pipes may be alternatively made of different materials such as polyvinyl chloride (PVC), high-density polyethylene (HDPE), iron or steel. Some dog chews on the market made of composite material can be found having a plain smooth surface. Drawbacks of these products include their lacking favorable surface texture and their incapability of providing good mechanical tooth cleaning effect.

### SUMMARY OF THE PRESENT DISCLOSURE

In an embodiment of the present disclosure, it is to provide a pet chew in a shape so that a natural shape of a dog's tooth may be accommodated while gnawing the chew.

In an embodiment of the present disclosure, it is to provide a pet chew in a shape that has a series of alternating ridges and grooves running/extending on the surface, so that dog's dental hygiene concerns are accommodated.

In some embodiments of the present disclosure, it is to provide an edible pet chew that is made of an edible composite material. In an embodiment, the edible composite material is a thermoplastic one.

In an embodiment of the present disclosure, it is to provide a pet chew with a kind of surface texture or surface structure that may well accommodate the shape (such as a profile wider at the base and pointed) and specification (such as tooth size) of a dog tooth so as to improve contact between dog tooth and the chew. Thus, improved oral cleaning action is achieved.

In some embodiments of the present disclosure, it is to provide an edible pet chew including a tubular (composite-material) component/member formed from a (artificial) composite material with a series of alternating (latitudinal) ridges and grooves (approximately) parallel to each other running/extending (latitudinally) on the surface.

In some embodiments of the present disclosure, it is to provide an edible pet chew including a component/member made of artificial composite material that approximates or imitates the shape of a plastic corrugate pipe or traditional dehydrated trachea chew (or esophagus chew).

In some embodiments of the present disclosure, it is to provide an edible pet chew including a (composite-material) component that approximates or imitates a shape, profile, structure, form, appearance or texture of a plastic corrugated pipe or traditional dehydrated trachea chew (or esophagus chew).

In some embodiments of the present disclosure, it is to provide a pet chew that is made of an edible composite material that is free of animal hide ingredient or free of rawhide.

In an embodiment of the present disclosure, it is to provide an edible pet chew including a tube-shaped (or pipe-shaped) component made of composite material with a series of alternating ridges and grooves (approximately) parallel to each other on the surface of it. The alternating ridges and grooves run/extend latitudinally on the surface (both ridges and grooves run/extend latitudinally on the surface) of the tube-shaped component. In at least one embodiment, the alternating ridges and grooves are approximately perpendicular to the (longitudinal) centerline (longest axis) of the tube-shaped component. In at least one embodiment, the tube-shaped (or pipe-shaped) component imitates the shape or appearance of a corrugated pipe or a dehydrated trachea chew (or esophagus chew).

In an embodiment of the present disclosure, it is to provide an edible pet chew including a corrugated-pipe-shaped or trachea-shaped component formed from a (artificial) composite material with satisfactory strength that can endure a dog's fairly long-time chewing activity before being swallowed.

In some embodiments of the present disclosure, it is to provide an edible pet chew including a corrugated-pipe-shaped component formed from (artificial) composite material so that the pet chew product may make consumers associate it with traditional trachea chew (or esophagus chew). Since trachea chew (or esophagus chew) is generally considered as providing joint health supporting benefits to dogs, in this fashion, a pet chew of the present disclosure may as well convey similar dog health benefit expectation or association to consumers. And alternatively, a further introduction of Glucosamine/Chondroitin substance to the formula of the pet chew may further accommodate or enhance the expectation or association.

In an embodiment of the present disclosure, it is to provide an edible pet chew including a corrugated-pipe-shaped or trachea-shaped component formed from a (artificial) composite material with a series of alternating ridges and grooves (approximately) parallel to each other on the surface of it. The alternating ridges and grooves run/extend latitudinally on the surface (both ridges and grooves run/extend latitudinally on the surface) of the corrugated-pipe-shaped or trachea-shaped component.

In an embodiment of the present disclosure, it is to provide an edible pet chew including a corrugated-pipe-shaped or trachea-shaped component formed from a (artificial) composite material with Helical (spiral) ridge(s) and groove(s) running/extending helically on its surface like a screw thread along its body.

In an embodiment of the present disclosure, it is to provide an edible pet chew including a curved “corrugated sheet” or a curved “ribbed sheet” (that is curved to form a tube shape or a hollow cylindrical shape) component in a tube shape or hollow cylindrical shape made of composite material (composition material). In at least one embodiment, the cross-section outline shape of the curved “corrugated sheet” or the curved “ribbed sheet” is a closed curve. There may be a series of alternating ridges and grooves (approximately) parallel to each other running/extending latitudinally on the surface of it (both ridges and grooves run/extend latitudinally on the surface), or alternatively Helical ridge(s) and groove(s) running/extending helically like a screw thread on its surface.

In an embodiment of the present disclosure, it is to provide an edible pet chew including a rolled “corrugated sheet” or rolled “ribbed sheet” (rolled up to a cylindrical form or a tubular form) component in a cylinder shape or tube shape made of composite material (composition material). The “corrugated sheet” or “ribbed sheet” may have been wrapped many times around itself so as to form a cylinder or a tube, or may have been wrapped just about one time to form a tube.

In yet another embodiment of the present disclosure, it is to provide an edible pet chew including a rolled “corrugated sheet” or rolled “ribbed sheet” (rolled up into a cylinder form or a tubular form) component in a cylinder shape or tube shape made of composite material (composition material), where there are a series of alternating ridges and grooves (approximately) parallel to each other running/extending longitudinally on the surface of it. The “corrugated sheet” or “ribbed sheet” may have been wrapped many times around itself so as to form a cylinder or a tube, or may have been wrapped just about one time to form a tube.

In an embodiment of the present disclosure, it is to provide an edible pet chew including a solid cylinder-shaped component made of composite material with a series of alternating ridges and grooves (approximately) parallel to each other on the surface of it. The alternating ridges and grooves run/extend latitudinally on the surface of the solid cylinder-shaped component. In at least one embodiment, the alternating ridges and grooves are approximately perpendicular to the (longitudinal) centerline (longest axis) of the solid cylinder-shaped component.

In an embodiment of the present disclosure, the edible pet chew (pet treat) includes a curved “corrugated sheet” or curved “ribbed sheet” component/member with a cross-section shape of an arc/curve (or especially a cross-section shape of an approximate Semicircle or Open Circle) with a series of alternating (latitudinal) ridges and grooves (approximately) parallel to each other latitudinally on its exterior surface approximately perpendicular to the (longitudinal) centerline (longest axis) of the curved “corrugated sheet” or curved “ribbed sheet” component/member. In at least one embodiment, the edible pet chew approximates or imitates the shape of a kind of trachea chew that is formed from a portion of natural trachea rather than a complete tube-shaped trachea which is served in a curved thin piece form with a cross-section shape of an arc/curve (or Semicircle).

In yet another embodiment of the present disclosure, it is to provide a rawhide (animal hide) pet chew including a traditional rawhide sheet (animal hide sheet) component, a reconstituted-rawhide sheet component, or a reconstituted-animal hide sheet component, in which the component has a series of alternating ridges and grooves (approximately) parallel to each other running/extending latitudinally on the surface (both ridges and grooves run/extend latitudinally on the surface).

In some embodiments of the present disclosure, it is to provide a pet chew including any one of: a trachea material, an esophagus material, a cartilage material, a naturally cartilage-rich material, a naturally glucosamine-rich material, a naturally chondroitin-rich material, a synthetic glucosamine, a synthetic chondroitin, a glucosamine supplement material, a chondroitin supplement material, a glucosamine compound, a chondroitin compound, a glucosamine sulfate, a chondroitin sulfate, a glucosamine hydrochloride, a chondroitin hydrochloride and any combination thereof, in the chew, providing joint health benefits to dogs. In an embodiment, it is to provide a pet chew including any one of: at least 3% trachea material, at least 3% esophagus material, at least 3% cartilage material, at least 3% naturally cartilage-rich material, at least 3% naturally glucosamine-rich material, at least 3% naturally chondroitin-rich material, at least 0.2% synthetic glucosamine, at least 0.1% synthetic chondroitin, at least 0.2% glucosamine supplement material, at least 0.1% chondroitin supplement material, at least 0.2% glucosamine compound, at least 0.1% chondroitin compound, at least 0.2% glucosamine sulfate, at least 0.1% chondroitin sulfate, at least 0.2% glucosamine hydrochloride, at least 0.1% chondroitin hydrochloride and any combination thereof, in the chew.

In some embodiments of the present disclosure, it is to provide a pet chew that is made of an edible (artificial) composite material including Glucosamine (substance) and/or Chondroitin (substance) in it, providing joint health benefits to dogs.

In some embodiments of the present disclosure, it is to provide a pet chew that is made of a composite/composition material including Glucosamine and/or Chondroitin (substance) in it, providing joint health benefits to dogs. The Glucosamine and/or Chondroitin substance existing in the composite/composition material may be presented as added Glucosamine (chemicals) and/or added Chondroitin (chemicals) that are added into the formula of the composite/composition. Alternatively, Glucosamine and/or Chondroitin substance existing in the composite/composition material may come from an ingredient of the formula of the composite/composition material, in which the ingredient is a naturally occurring material inherently including Glucosamine and/or Chondroitin substance in it. For example, the ingredient is one of cartilage, trachea, esophagus, shark cartilage, crab shell and tendon which provides inherent (natural) source of Glucosamine and/or Chondroitin substance (chemical) to it.

An embodiment of the present disclosure is to provide a pet chew that is made of an edible (artificial) composite material including an animal Natural Parts material (or naturally occurring animal material, or natural organ material) that inherently/naturally contains Glucosamine and/or Chondroitin in it, such as animal cartilage, trachea, esophagus and tendon, in its composition, providing joint health benefits to dogs. Animal cartilage, trachea, esophagus, shark cartilage, crab shell, tendon and other similar materials as Glucosamine/Chondroitin rich ones can provide natural source of Glucosamine/Chondroitin to the pet chews, as well as collagen and protein.

An embodiment of the present disclosure is to provide a pet chew that is made of an edible (artificial) composite material including a naturally-cartilage-rich animal material in the formula that inherently/naturally contains Glucosamine and/or Chondroitin in it, such as animal ear, trachea, esophagus and tendon, providing joint health benefits to dogs. Animal ear, trachea, esophagus, tendon and other similar materials that include cartilage material in the composition, as Glucosamine/Chondroitin rich ones, can provide a natural source of Glucosamine/Chondroitin to the pet chews, as well as collagen and protein.

In some embodiments of the present disclosure, it is to provide an edible pet chew including a corrugated-pipe-shaped or trachea-shaped component formed from a (artificial) composite material, in which the corrugated-pipe-shaped or trachea-shaped component includes Glucosamine (substance) and/or Chondroitin (substance) in the material.

An embodiment of the present disclosure is to provide an edible pet chew including a corrugated-pipe-shaped or trachea-shaped component formed from a (artificial) composite material, in which the corrugated-pipe-shaped or trachea-shaped component includes animal cartilage material in its formula.

In some embodiments of the present disclosure, it is to provide an edible pet chew including a tubular component/member formed from a (artificial) composite material, which is a hollow object. The hollow structure of the tubular component/member may allow consumers to fill additional edible materials or treats into it, both of which are served together to their dogs, or may accept additional edible material filling (stuffing) component before obtaining finished products.

In some embodiments of the present disclosure, it is to provide an edible pet chew including a corrugated-pipe-shaped or trachea-shaped Tubular component/member formed from a (artificial) composite material including a series of alternating (latitudinal) ridges and grooves running (approximately) parallel to each other on its exterior surface approximately perpendicular to the (longitudinal) centerline (longest axis) of the tubular component/member. The cross-section shape of the Tubular component may be various as desired. The cross-section shape (cross-section perpendicular to the longitudinal centerline of the component and at various point of the length) of the Tubular component may be a closed curve (usually a closed circle) or alternatively an open curve (usually an open circle). The tubular component/member may be formed in a way that an initially-flat extruded corrugated-sheet material (or initially-flat extruded ribbed-sheet material) is prepared and then rolled up into a tube with a series of alternating ridges and grooves (approximately) parallel to each other running/extending latitudinally on its exterior surface (a similar forming process may refer to the Process 0900A from FIG. 9). The “flat” from “initially-flat extruded corrugated-sheet” and “initially-flat extruded ribbed-sheet” in a broad sense means an object is not very tall or deep in relation to its length and width and its surface does not have to be smooth. Or, it may be formed in a way that an initial sheet material (the sheet may be formed by extrusion process) is formed into a corrugated-sheet material (or ribbed-sheet material) by for example roller forming process having a series of alternating ridges and grooves on the surface and the corrugated-sheet material (or ribbed-sheet material) is rolled up into a tube with a series of alternating ridges and grooves (approximately) parallel to each other running/extending latitudinally on its exterior surface (a similar forming process may refer to the Process 0900C or Process 0900D from FIG. 9). Or, it may alternatively be formed in a way that a composite material is prepared, fed to an extruder, extruded and then is molded by a running corrugation mold block chain in the aid of vacuum or blowing treatment to take a series of alternating (latitudinal) ridges and grooves on the surface as soon as it leaves the long thin extruder die head (a similar forming process may refer to the Process 0900B from FIG. 9). Or, it may be alternatively formed by an injection-molding process, which creates a hollow corrugated-pipe-shaped or trachea-shaped Tubular composite-material component/member with a series of alternating (latitudinal) ridges and grooves on the surface (a similar forming process may refer to the Process 1000F from FIG. 10). The aforementioned ridges may be in an O-shape (complete circle or closed circle) or a C-shape (incomplete circle or open circle). The aforementioned ridges may be in a closed-curve shape or an open-curve shape.

These embodiments of the present disclosure will become apparent from the following detailed description, the accompanying drawings, and the appended claims.

### BRIEF DESCRIPTION OF THE DRAWINGS

FIG. 1 is a view of a pet chew according to an embodiment of the present disclosure in a hollow tube form with a series of alternating ridges and grooves running/extending latitudinally on the surface.

FIG. 2 are views of nine separate pet chews according to embodiments of the present disclosure in a hollow tube form with various cross-section shapes, each of which has a series of alternating ridges and grooves running/extending latitudinally on the surface or a helical ridge extending from one end of the chew to the other.

FIG. 3 is a side view of a pet chew according to an embodiment of the present disclosure in a twisted shape, formed from a tube form material with a series of alternating ridges and grooves running/extending latitudinally on the surface.

FIG. 4 is a side view of a pet chew according to an embodiment of the present disclosure in a knotted bone shape, formed from a hollow tube with a series of alternating ridges and grooves running/extending latitudinally on the surface.

FIG. 5 shows two examples of Corrugated Sheet and two examples of Ribbed Sheet that serve as materials to form embodiments of present disclosure.

FIG. 6 are views of two separate pet chews according to embodiments of the present disclosure and their cross-sections, one of which is a pet chew in a tube form with a series of alternating ridges and grooves running/extending latitudinally on the surface, being formed from a rolled (curved) “ribbed sheet” that was wrapped just about one time, and the other of which is a pet chew in a solid cylinder form formed from a rolled ribbed sheet that was wrapped many times around itself.

FIG. 7 shows various cross-section shape examples that are classified into two separate groups, “closed curves/closed circles” and “open curves/open circles”.

FIG. 8 shows six separate longitudinal-section shapes that a tube-formed pet chew according to embodiments of the present disclosure with a series of alternating ridges and grooves running/extending latitudinally on the surface may present.

FIG. 9 shows three different manufacturing processes that may be potentially applied in order to form a tube-formed or cylinder-formed pet chew with a series of alternating ridges and grooves running/extending latitudinally (or longitudinally) on the surface according to embodiments of the present disclosure.

FIG. 10 shows two different manufacturing processes that may be potentially applied in order to form a tube-formed or cylinder-formed pet chew with a series of alternating ridges and grooves running/extending latitudinally (or longitudinally) on the surface according to embodiments of the present disclosure.

FIG. 11 illustrates a pet chew (in a longitudinal-section view) in a tube form with a series of alternating ridges and grooves running/extending latitudinally on the surface is being gnawed by teeth of a dog.

FIG. 12 are views of seven separate pet chews in a curved “ribbed sheet” form or curved “corrugated sheet” form with a cross-section shape of a curve or an arc and with a series of alternating ridges and grooves running/extending latitudinally on the surface.

FIG. 13 are views of seven separate pet chews according to embodiments of the present disclosure in a solid cylinder form with various cross-section shapes, each of which has a series of alternating ridges and grooves running/extending latitudinally on the surface or a helical ridge extending from one end of the chew to the other like a screw thread.

FIG. 14 is a view of a pet chew according to an embodiment of the present disclosure including a natural rawhide sheet component rolled up into a hollow tube form and a natural trachea (or esophagus) component wrapped therein, in which the natural rawhide sheet component has a series of alternating ridges and grooves running/extending latitudinally on the surface.

FIG. 15 are views of five separate pet chews according to embodiments of the present disclosure, three of which are formed from a rolled corrugated sheet, and other two of which include a rolled corrugated sheet component and an additional edible material component, in which these pet chews have a series of alternating ridges and grooves running/extending on the surface.

FIG. 16 is a view of a pet chew according to an embodiment of the present disclosure in a hollow tube form with a series of alternating ridges and grooves running/extending latitudinally on the surface, in which the upper parts of the ridge surfaces are coated with edible coating materials.

FIG. 17 is a side view and a longitudinal section view of a pet chew according to an embodiment of the present disclosure in a hollow tube form with a series of alternating ridges and grooves running/extending latitudinally on the surface.

FIG. 18 are views of two separate pet chews according to embodiments of the present disclosure in a hollow tube form with a series of alternating latitudinal ridges and grooves running/extending on the surface, the left one of which has a cross-section shape of water-drop icon and the right one has a round cross-section shape.

FIG. 19 are prior arts, three separate pet chews formed from a trachea segment cut from a natural trachea, with a series of alternating ridges and grooves running/extending on the surface. The longest one of the three is in a long curved piece form with an approximate cross-section shape of a semi-circle. The other two are in a curved piece form with a cross-section shape of an arc or a curve.

### DETAILED DESCRIPTION OF THE DISCLOSURE

Embodiments are provided in the following description only as examples. The general principles defined in the following description would be applied to other embodiments, alternatives, modifications, equivalents, and applications without departing from the spirit and scope of the present disclosure.

The term of “composite” or “composition” in the present disclosure generally refers to a material made of two or more distinct materials (ingredients). For example, a tubular pet chew component is formed from a plant-based “composite” material, where the composition of the plant-based composite material includes the ingredients of corn starch and glycerin (two distinct ingredients herein). Again, for example, a corrugated-sheet component is formed from a plant-based “composite” material, where the composition of the plant-based composite material includes the ingredients of corn starch, ground chicken and glycerin (three distinct ingredients herein). Again, for example, a ribbed-sheet component formed from an animal hide-based “composite” material, where the composition of the animal hide-based composite material includes the ingredients of ground rawhide and sorbitol (two distinct ingredients herein). The “composite” material (or composition material) may be a plant-based material, or an animal-ingredient based material, or an animal hide-based material. Usually, a “composite” material is an artificial material rather than a naturally occurring material. Examples of the aforementioned naturally occurring materials are rawhide sheet, animal hide sheet, esophagus and trachea. Edible pet chews may be divided into two categories, the Natural Chews (such as the chews derived from a certain Natural (Body) Parts (organ) of a slaughtered animal) and the Composite Chews (chews made of composite materials or artificial composite materials). “Natural Chews” generally are made of naturally occurring materials such as beef trachea, beef rawhide sheet, chicken breast, beef hooves, beef bones, antler, etc. “Natural part (organ)” generally refers to a part (an organ) of a slaughtered animal such as beef rawhide or skin, beef bones, chicken leg, pizzle, beef tendon, chicken breast, trachea, esophagus, chicken liver, etc. Trachea may also be called windpipe. Trachea chews (or esophagus chews) made of trachea may have limited supply of raw material employed to produce, high fat content, insufficient elasticity (although strong stiffness), no space to adjust ridge/groove sizes, limited flexibility to adjust joint health supporting material content and a finished product made of a trachea material may have limited structure or shape varieties due to the stiffness quality of the raw material and may have carpet stains concerns.

The term of “longitudinal” or “longitudinally” generally means “running/extending from one end of an object to the other rather than across it from side to side; in a direction or position along the length of something”. In contrast, “latitudinal” or “latitudinally” in the present disclosure generally means “in a direction widthwise, or horizontally, or substantially perpendicular to the centerline (longest axis) of an object”. For example, when something extends “latitudinally” on/in the surface of a tubular object, it runs/extends along a circumference of the tubular object in a direction substantially perpendicular to the centerline (longest axis) of the tubular object. In the circumstance that an object is a curved one (especially a curved corrugated sheet or a curved ribbed sheet), “latitudinally” may refer to “along the curve direction”.

It should be noted that the term of “rawhide sheet” or “rawhide” in a narrow sense refers to skin or leather that comes from a bovine such as cattle, and has not been treated or tanned. The term of “rawhide sheet” or “rawhide” in a broad sense (the definition almost equal to a term of “animal hide”) in the present disclosure is a most popular material to form dog chews in the pet industry, generally referring to skin/hide by-product(s) obtained from a slaughter of animals (especially hoofed animals such as bovine, swine, cattle, cow, water buffalo, pig, sheep, goats, marsupial, deer and elk, not limited to bovine), in which the “porkhide” falls within the definition of this “rawhide”. The hide is not exposed to tanning process and generally fur, meat and fat is removed. It may also be called traditional rawhide or natural rawhide. The dry material of traditional rawhide sheet is mainly made of fibrous proteins, collagen, keratin, elastin and reticulin and water. In an even broader sense, the term of “rawhide sheet” or “rawhide” also includes the material of reconstituted-rawhide sheet and reconstituted-animal hide sheet. The term of “reconstituted rawhide” (or “reconstituted rawhide sheet”, or “formed rawhide sheet”) generally refers to a material made of comminuted/ground rawhide or split/defibered rawhide fibers by re-forming back into a sheet form (sheet re-forming processing method includes, but not limited to, extruding ground rawhide composition with heat to a sheet form, or defibering collagen fibers then having them reconstituted into a sheet form, etc.). The “formed rawhide sheet” may also be called ground-and-formed rawhide. It may employ leftovers or scraps of rawhide from traditional rawhide sheet productions and have the rawhide leftovers or scraps re-formed back into a sheet form. The term of “animal hide-based” refers to a composite/composition material including substantially at least 20% animal hide ingredient(s) and 0.1%-49.9% plant ingredient(s) by weight in the formula. All animal hide ingredients existing in the “animal hide-based” composite/composition added together may account for the number one proportion ingredient(s) in the material by weight, which is larger than any other individual (or single) non-animal hide ingredient existing in the material, such as vegetables, corn starch, isolated soybean protein, glycerin, chicken, chicken liver, glycerin, sugar and sorbitol. Non-animal hide ingredient(s) existing in the material may be any one of plant ingredient, animal ingredient (excluding animal skin), chemicals and a combination thereof. Typically, the “animal hide-based” material includes substantially at least 50% animal hide ingredient(s) by weight in the formula.

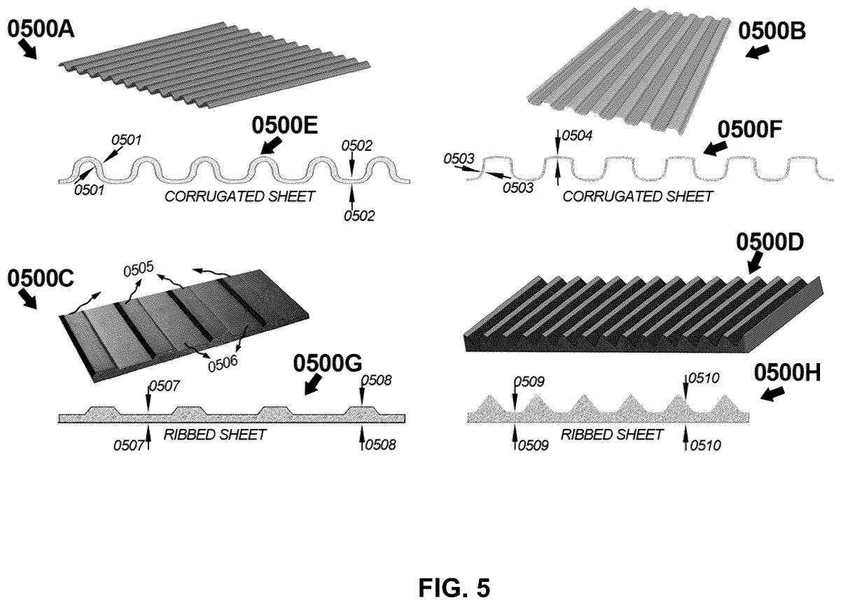

In a narrow sense, the term of “sheet” refers to a thin flat material, which is thin in comparison to its length and breadth, typically in a square or rectangular shape, of which both opposite sides (the top side and the bottom side) are substantially smooth and of which the thickness is substantially homogeneous throughout the material. While referring a material is “thin”, it means that the distance between the two opposite sides (the top side and the bottom side) of the material in comparison to its length and breadth is small. Typically, the average thickness of the “sheet” ranges from 0.3 mm to 10 mm. Alternatively, the “sheet” may be in any desired shape or form other than the aforementioned rectangular shape. In a broad sense, the term of “sheet” refers to a thin material, which is thin in comparison to its length and breadth, typically in a square or rectangular shape, the sides of which may be smooth or textured (or rough). The term of “sheet” in the present disclosure in some circumstance may refer to the aforementioned narrow sense. For example, the “sheet” from the “corrugated sheet” in the present disclosure may refer to a sheet in the narrow sense, whereas the “sheet” from the “ribbed sheet” in the present disclosure may refer to a sheet in the broad sense instead. The term of “corrugated sheet” generally refers to a thin material that is formed into a shape of a series of (approximately) parallel folds that may look like waves, typically whose sheet material thickness is substantially homogeneous throughout the material. For example, a material initially being a flat sheet is re-formed to take a series of parallel folds. As shown in FIG. 5, the material of 0500A is referred as a corrugated sheet with parallel folds resembling waves, whose material thickness is substantially homogenous through the material (for example, thickness 0501 appears approximately equal to thickness 0502 that are measured at two different points of the material). 0500B refers to another corrugated sheet with approximately equal thickness values measured at point 0503 and point 0504. The term of “ribbed sheet” generally refers to a material in a sheet form (the sheet herein refers to the one in a broad sense) having a raised pattern of (approximately) parallel lines on it. Usually, the material thickness of raised line parts of a “ribbed sheet” is significantly larger than that of the non-raised parts. As shown in FIG. 5, the material of 0500C is referred as a ribbed sheet with a raised pattern of parallel lines 0505 which appears raised from the material base 0506. The thickness 0508 measured at a raised line is thicker than thickness 0507 measured at the base. 0500D refers to another ribbed sheet material with a thickness value 0510 much greater than that of 0509. It should be noted that, while referring a material is “flat” in a broad sense, it means that the material is not very tall or deep in relation to its length and width and its surface does not have to be smooth, such as the “flat” from “initially-flat corrugated-sheet” and “initially-flat ribbed-sheet that may have a textured surface.

The term of “tube” (or “tubular”, or “pipe”, or tube-formed) in the present disclosure generally refers to a long hollow object that may be round or not, whose cross-section shape may be various as desired. A typical cross-section of the tube/pipe is in a round (circular) outline (profile) shape or in a closed-curve outline (profile) shape. But the outline (profile) shape of the tube's/pipe's cross-section may be in other various shapes, such as an oval shape, a triangular shape, a rounded-rectangular shape, a polygonal shape, a shape resembling Arabic numerals “8”, a shape resembling Arabic “9” in the font of “TW Cen MT”, a shape of water-drop icon, a shape of comma of punctuation mark, and irregular shapes. Typically, the average wall thickness of it ranges from to 0.3 mm to 20 mm. In some embodiments of the present disclosure, the exterior surface of the tube/pipe is in a corrugated or ribbed texture. In the drainage pipe industry or plastic corrugated tubing (such as cable tubing) industry, it provides a kind of popular pipes/tubes with a series of alternating ridges and grooves running parallel to each other on its surface latitudinally. Alternating ridges and grooves are created thereon, being arranged alternately on the surface. The ridges and grooves may follow a pattern that is perpendicular to the centerline (longest axis) of the pipe. The pipes may be called Corrugated Pipes. A regular corrugated pipe may have homogeneous ridge height, and spaces/distance between every and groove. Alternatively, ridges and grooves on the surface of some corrugated pipes may be in another form of helix (spiral) running/extending from one end to the other of the pipes like a screw thread, where these pipes are also classified as corrugated pipes though they merely occupy a minority part of the corrugated pipe industry.

The term of “starch” in the present disclosure generally refers to a carbohydrate food substance obtained from a plant. Some examples are starches derived from potato, sweet potato, mung bean, wheat, corn, tapioca, rice, pea and mixtures thereof. The starch can be used in its native form, but may also be physically or chemically modified before being applied. Of course, it is also possible to use combinations of native starch and modified starch, or combinations of different modified starches.

It should be noted that the term “plant” in the present disclosure generally refers to an edible part of a plant or an edible material derived from a plant, where the plant material is selected from, but not limited to, the group consisting of: a plant material (such as potato, sweet potato, mung bean, wheat, corn, tapioca, rice, pea, soybean, peanut, almond, mushroom, legumes, beans, grains, chia seed, algae, seaweed, spirulina, cereals and mixtures thereof), a material of edible part of a plant, a plant derived material, a plant protein, a plant starch, a plant fiber, a vegetable material, a vegetable derived material, a vegetable protein, a vegetable starch and mixtures thereof.

The term of “plant-based” refers to a composite (or composition) material including substantially at least 20% plant ingredient(s) by weight in the formula. Typically, the “plant-based” material includes substantially at least 40% plant ingredient(s) by weight in the formula. More typically, the “plant-based” material includes substantially at least 50% plant ingredient(s) by weight in the formula. Usually, all plant ingredients (such as plant starch, plant protein, and plant fibers) existing in the “plant-based” composite/composition added together account for the number one proportion ingredient(s) in the material by weight, which is larger than any other individual (or single) non-plant ingredient existing in the material, such as glycerin, chicken, chicken liver, sugar and sorbitol. Non-plant ingredient(s) existing in the material may be any one of animal ingredient, animal hide ingredient, chemicals and a combination thereof. Preferably, a plant-based material of the present disclosure is free of animal hide ingredients or free of rawhide ingredients.

The term of “animal ingredient” in the present disclosure refers to the materials obtained from a slaughtered animal, including meat, meat by-product(s) or a combination thereof, other than skin, feather, horn, hair, teeth, hooves. The term of “meat” generally refers to the clean flesh derived from slaughtered animals (including but not limited to mammals, livestock, bovine, swine, cattle, pig, poultry, chicken, duck, turkey and fish) and is limited to that part of the striate muscle which is skeletal or that part which is found in the tongue, in the diaphragm, in the heart or in the esophagus; with or without the accompanying and overlying fat, sinew, nerve and blood vessels which normally accompany the flesh. In other words, “meat” is primarily the muscle tissue of an animal. Exemplary materials are chicken flesh, beef, pork, fish flesh. The term of “meat by-products” generally refers to the non-rendered, clean parts, other than meat, derived from slaughtered animals (such as mammals, fish, and poultry), which includes, but is not limited to, lungs, spleen, kidneys, brain, livers, blood, bone, partially defatted low-temperature fatty tissue, stomachs and intestines free of their contents and a combination thereof “Meat by-products” may also be a material selected from the group consisting of: milk, milk powder, milk-derived material, cheese, cheese-derived material, whey, whey protein powder, whey-derived material, egg, and egg-derived material. Some other exemplary materials are chicken liver, bovine tendon, bovine lungs, porcine fat, beef bone powder and pig stomach.

The term of “animal ingredient based” material refers to a composite (or composition) material including substantially at least 10% animal ingredient(s) and 5%-49.9% plant ingredient by weight. Alternatively, all animal ingredients (such as chicken flesh, beef, pork, goat muscle, chicken liver, bovine tendon, animal lungs, porcine fat, animal bone powder, animal stomach, etc.) existing in the “animal ingredient based” composite/composition added together may account for the number one proportion ingredient(s) by weight in the material, which is larger than any other individual (or single) non-animal ingredient existing in the material, such as potato starch, ground pea, isolated soybean protein, plant starch, plant protein, ground rawhide, glycerin, sugar, sorbitol. Non-animal ingredient(s) existing in the material may be any one of plant ingredient, animal hide ingredient, chemicals, and a combination thereof. Preferably, the animal ingredient-based material is free of animal hide ingredients or free of rawhide. Typically, the “animal ingredient based” composite/composition material includes substantially at least 25% animal ingredient(s) and 5%-49.9% plant ingredient(s) by weight. “Meat based” material refers to a composite (or composition) material including substantially at least 10% meat ingredient(s) and 5%-49.9% plant ingredient(s) by weight. Typically, the meat-based material composite (or composition) includes substantially at least 25% meat ingredient(s) and 5%-49.9% plant ingredient(s) by weight. All meat ingredients (such as chicken breast, duck, beef, pork, goat muscle, etc.) existing in the “meat based” composite/composition added together may account for the number one proportion ingredient(s) by weight in the material, which is larger than any other individual (or single) non-meat ingredient existing in the material, such as potato starch, ground pea, isolated soybean protein, plant starch, plant protein, chicken liver, bovine pizzle, bovine tendon, glycerin, sugar, and sorbitol.

“Attractant” material (it may also be called flavor material) in the present disclosure may refer to a material having a flavor that is applied to entice pets/dogs to chew on and eat. Examples of the attractant are meat ingredient, meat by-products ingredient, chicken liver, hydrolyzed animal protein, hydrolyzed chicken liver, poultry digest, chicken digest, artificial beef flavor, artificial pork flavor and brewer yeast.

It should be noted that the term “assemble” means to fit together all separate parts/members/components of a pet chew product. For example, several separate components of a pet chew are manipulated (such as knotting, wrapping, rolling, folding and twisting) by hand or by molded/rolling process by machine to have the components together form a pet chew product in a predetermined relationship.

It should be noted that, the term of “curved” from the “curved Corrugated Sheet” object refers to a corrugated-sheet material in a shape of curve or with a smoothly bending surface. The cross-section of the “curved Corrugated Sheet” may be in a shape of a curve, such as an open curve and a closed curve. The term of “curved” from the “curved Ribbed Sheet” object refers to a ribbed-sheet material in a shape of curve or with a smoothly bending surface. The cross-section of the “curved Ribbed Sheet” may be in a shape of a curve, such as an open curve and a closed curve. “Glucosamine” in the present disclosure may refer to a Glucosamine chemical, or a Glucosamine molecule, or a Glucosamine compound, or a Glucosamine supplement, or a compound containing Glucosamine. “Chondroitin” in the present disclosure may refer to a Chondroitin chemical, or a Chondroitin molecule, or a Chondroitin compound, or a Chondroitin supplement, or a compound containing Chondroitin. Glucosamine/Chondroitin may be introduced to the pet chews of the present disclosure by two means described as follows: A), directly applying a synthetic Glucosamine/Chondroitin supplement substance or Glucosamine/Chondroitin supplement substance obtained by extraction and/or chemical process (examples include glucosamine sulfate, glucosamine hydrochloride (HCL), N-acetyl-glucosamine or MSM glucosamine, glucosamine chondroitin, glucosamine chondroitin sulfate, glucosamine chondroitin MSM, chondroitin sulfate, chondroitin sulfate sodium, and chondroitin hydrochloride) into the formula as an ingredient; B), by applying an animal material rich in naturally-occurring-Glucosamine/Chondroitin (or a naturally-Glucosamine/Chondroitin-rich animal material, or a naturally-cartilage-rich animal material) into the formula as an ingredient. The naturally-Glucosamine/Chondroitin-rich animal material (or naturally-cartilage-rich animal material) is selected from (but not limited to) the group consisting of: animal cartilage (such as chicken cartilage, bovine cartilage), animal trachea (such as bovine trachea, lamb trachea, pork trachea), animal esophagus, shellfish shells, fungus, mushrooms, animal tendon (such as bovine tendon, turkey tendon), poultry foot (such as chicken foot, duck foot, turkey foot), mussel meat, animal lungs, animal bones, animal bone marrow, animal tails (Oxtails, Pig Tails, lamb tail), animal ear (such as pig ear), eggshell membrane and any combination thereof.

In embodiments of the present disclosure, it is to provide a tubular pet chew in a shape that has a series of alternating ridges and grooves running/extending on the surface, so that dog tooth cleaning actions are provided hereby. In some embodiments, the alternating ridges and grooves run/extend latitudinally on the surface.

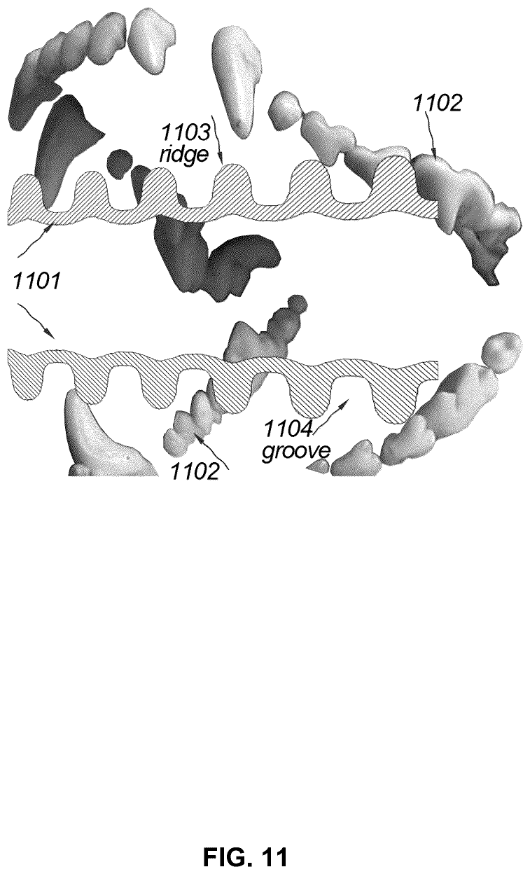

In an embodiment of the present disclosure, it is to provide a pet chew with a kind of surface texture or surface structure that can well accommodate the shape (such as a profile wider at the base and pointed), specification and dimension (such as tooth size) of a dog tooth so as to improve contact between dog tooth and the chew. Thus, improved oral cleaning action is achieved. Preferably, there are a series of alternating (latitudinal) ridges and grooves on the surface. In at least one embodiment, the aforementioned “series of alternating ridges and grooves” includes at least three ridges and two grooves. Refer to FIG. 11, Pet Chew 1101 (in a longitudinal-section view) in a tube form with a series of alternating ridges and grooves running/extending latitudinally on the surface is being gnawed by dog teeth 1102. The size and shape of dog teeth 1102 may be accommodated by the alternating ridges 1103 and grooves 1104 while gnawing on the chew. And the alternating ridges 1103 and grooves 1104 may guide a dog tooth to a groove area when the dog is in the process of biting the chew, and thus tartar and plaque may be mechanically removed. And the presence of the alignment of repeating ridge-groove-ridge-groove may greatly increase the chance of a tooth (that is located at a different position of a dog's mouth) being accepted by a groove.

In an embodiment of the present disclosure, it is to provide a pet chew that is made of an edible (artificial) composite material that is free of animal hide ingredient or free of rawhide. For an edible (artificial) composite material that serves as a material to form a pet chew, the presence of animal hide or rawhide ingredient in that edible composite material may bring the following drawbacks to the pet chew. A), Animal hide material or rawhide material does not have inherently-attractive flavor urging dogs to chew. B), Manufacture of animal hide or rawhide is a relatively unregulated industry. It may create pollution to the environment. C), The residues of NH₄CL, H₂O₂ and NaOH chemicals that are used in rawhide manufacture may bring health jeopardy to dogs. D), Heavy metals may remain in finished products made of the animal hide or rawhide, which may harm dogs' health.

In an embodiment of the present disclosure, it is to provide an edible pet chew including a corrugated-pipe-shaped or trachea-shaped component formed from a (artificial) composite material with a series of alternating ridges and grooves (approximately) parallel to each other on the surface of it. The alternating ridges and grooves run/extend latitudinally on the surface of the corrugated-pipe-shaped or trachea-shaped component. In at least one embodiment, the alternating ridges and grooves are approximately perpendicular to the centerline (longest axis) of the corrugated-pipe-shaped or trachea-shaped component. In at least one embodiment, the aforementioned “series of alternating ridges and grooves” includes at least three ridges and two grooves. In at least one embodiment, the ridges are in an O-shape (complete circle or closed circle) or a C-shape (incomplete circle or open circle). In at least one embodiment, the ridges are in a closed-curve shape or an open-curve shape. In some embodiments, the corrugated-pipe-shaped or trachea-shaped component is made of edible thermoplastic material.

In an embodiment of the present disclosure, it is to provide an edible pet chew including a corrugated-pipe-shaped or trachea-shaped component formed from a (artificial) composite material with Helical (spiral) ridge(s) and groove(s) like a screw thread running/extending helically on its surface along its body. In some embodiments, the corrugated-pipe-shaped or trachea-shaped component is made of edible thermoplastic material.

In some embodiments of the present disclosure, it is to provide an edible pet chew including a corrugated-pipe-shaped or trachea-shaped component formed from a (artificial) composite material, in which the corrugated-pipe-shaped or trachea-shaped component includes Glucosamine (substance) and/or Chondroitin (substance) or a naturally-Glucosamine/Chondroitin-rich material in it.

An embodiment of the present disclosure is to provide an edible pet chew including a corrugated-pipe-shaped or trachea-shaped component formed from a (artificial) composite material, in which the corrugated-pipe-shaped or trachea-shaped component includes an animal cartilage material or a naturally-cartilage-rich animal material in its formula.

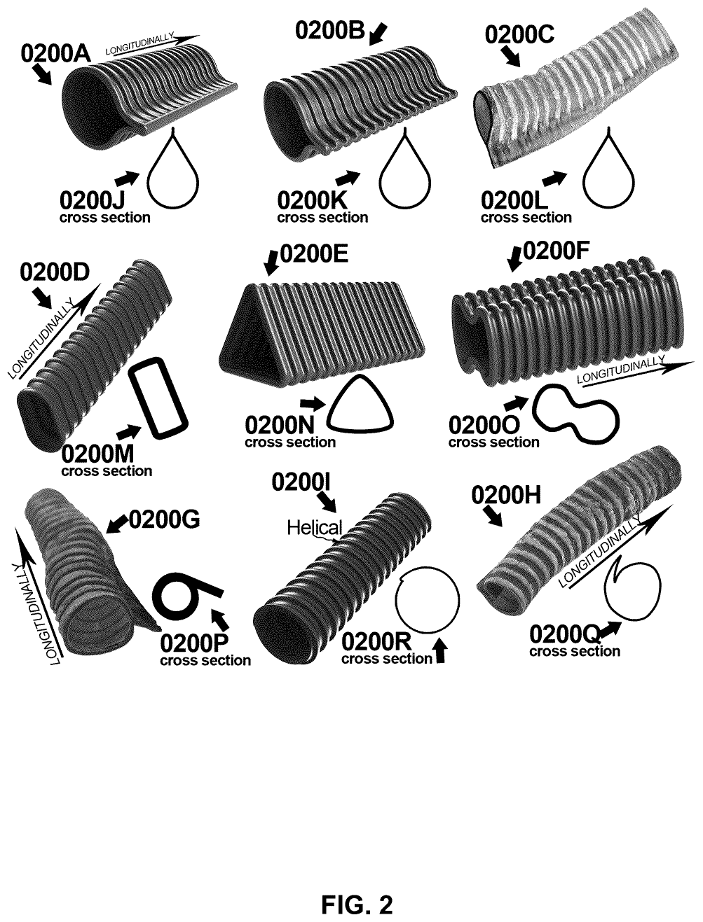

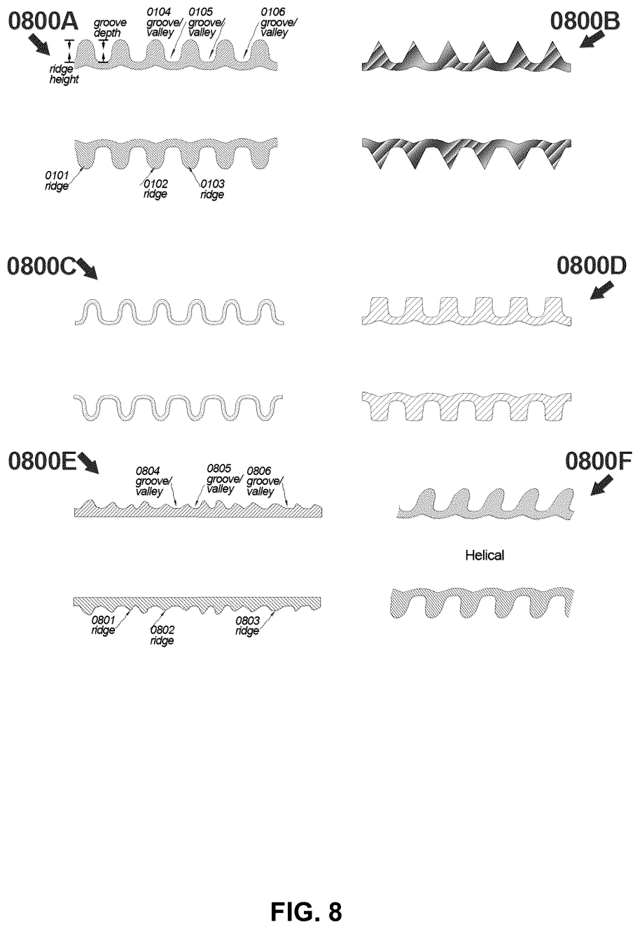

In one aspect of the present disclosure, an edible pet chew (pet treat) includes a tubular (composite-material) component/member formed from a (artificial) composite material with a series of alternating (latitudinal) ridges and grooves (approximately) parallel to each other running/extending (latitudinally) on the surface. In at least one embodiment, the aforementioned “series of alternating ridges and grooves” includes at least three ridges and two grooves. As shown in FIG. 8, various longitudinal-section shape examples that a pet chew formed from a tubular component with a series of alternating ridges and grooves running/extending latitudinally on the surface (both ridges and grooves run/extend latitudinally on the surface) according to embodiments of the present disclosure may present are illustrated therein. In some embodiments of this aspect, the tubular component is a Corrugated-Pipe-shaped one. In yet some embodiments of this aspect, the tubular component is a Trachea-chew-shaped one. In at least one embodiment, the ridges and grooves are approximately perpendicular to the (longitudinal) centerline (longest axis) of the tubular (composite-material) component. Preferably, the average height of the ridges is at least 0.5 mm (more preferably at least 1 mm), or the average depth of the grooves is at least mm (more preferably at least 1 mm). In some embodiments, the length of a ridge is equivalent to at least 50% of the circumference of the material on where it runs/extends. In some preferred embodiments, the length of the tubular component that the ridges and grooves together extend on accounts for at least 50% of the entire length of the tubular component. In some preferred embodiments, the area that the ridges and grooves together cover accounts for at least 50% of the total area of the exterior surface of the tubular component. In some embodiments, the aforementioned tubular (composite-material) component is in various forms such as the ones with alternating ridges and grooves running/extending on the surface as illustrated in FIG. 2, from which 0200A/0200B/0200C have cross-section shapes 0200I/0200K/0200L of a water-drop icon; 0200D, a cross-section shape 0200M of a rounded-rectangle; 0200E, a cross-section shape 0200N of a tri-angle; 0200F, a cross-section shape 0200O of an Arabic “8”; 0200G, a cross-section shape 0200P of an Arabic “9” in the font of “Tw Cen MT”; 0200H, a cross-section shape 0200Q of a comma of a punctuation mark; 0200I, a cross-section shape 0200R of a circle. It is foreseen that the aforementioned tubular (composite-material) component may be in any other desired forms other than the above-listed ones, such as the rounded-rectangular one and the triangular one, whose cross-section may present any other (appropriate) shapes as pre-determined. In some preferred embodiments of this aspect, the tubular (composite-material) component is formed from a plant-based (vegetable-based) material. In an embodiment, the aforementioned plant-based material includes at least 20% plant (vegetable) ingredient by weight in formula. In yet another embodiment, the aforementioned plant-based material includes at least 40% plant (vegetable) ingredient by weight in the formula. In yet some other embodiments in this aspect, the tubular (composite-material) component is formed from an animal ingredient-based material. In an embodiment, the aforementioned animal ingredient-based material includes substantially at least 10% animal ingredient(s) by weight and 5%-49.9% plant ingredient by weight in formula. In yet some other embodiments in this aspect, the tubular (composite-material) component is formed from an animal hide-based material. In some embodiments, the tubular (composite material) component in this aspect of the present disclosure includes Glucosamine and/or Chondroitin (such as chemical, compound and molecule) in it, where the Glucosamine/Chondroitin may be introduced to the composite material by directly applying a synthetic Glucosamine/Chondroitin supplement or a Glucosamine/Chondroitin supplement substance obtained by extraction and/or chemical process (examples include glucosamine sulfate, glucosamine hydrochloride (HCL), N-acetyl-glucosamine or MSM glucosamine, glucosamine chondroitin, glucosamine chondroitin sulfate, glucosamine chondroitin MSM, chondroitin sulfate, chondroitin sulfate sodium and chondroitin hydrochloride), or by applying a naturally-Glucosamine/Chondroitin-rich animal material such as trachea, cartilage, esophagus and tendon or naturally-cartilage-rich animal material such as animal ear, trachea and esophagus. In some embodiments, the tubular (composite material) component includes Glucosamine in the formula. In an embodiment, the tubular (composite material) component includes at least 0.2% Glucosamine by weight in the formula. In some embodiments, the tubular (composite material) component includes Chondroitin in the formula. In an embodiment, the tubular (composite material) component includes at least 0.1% Chondroitin by weight in the formula. In some embodiments, the tubular (composite material) component includes a naturally-Glucosamine/Chondroitin-rich animal material in the formula. In an embodiment, the tubular (composite material) component includes at least 3% naturally-Glucosamine/Chondroitin-rich animal material by weight in the formula. In an embodiment, the tubular (composite material) component includes at least 3% animal cartilage by weight in the formula. In an embodiment, the tubular (composite material) component includes at least 3% trachea and or esophagus material by weight in the formula. In some embodiments, the tubular (composite material) component is free of animal hide ingredient or free of rawhide in the composition. In at least one embodiment, the ridges are in an O-shape (complete circle or closed circle) or a C-shape (incomplete circle or open circle). In at least one embodiment, the ridges are in a closed-curve shape or an open-curve shape. In some embodiments, the tubular component is made of edible thermoplastic material. In some embodiments, the alternating ridges and grooves existing on the surface of the tubular component are formed by an injection molding process, a compression molding process or a roller forming process, in which the mold applied in the injection molding process (or a compression molding process) or the roller in the roller forming process has a series of alternating ridges and grooves.

A dog chew in an embodiment of the present disclosure formed from a (artificial) composite material is created in a shape, appearance, structure or form similar or identical to a corrugated pipe, it may offer at least one of the following benefits. A), It provides improved and efficient tooth cleaning performance. The alternating ridges and grooves (valleys) offer a great chance for most individual tooth positioned differently within a dog mouth to be caught by cavities created by the ridges and grooves, thus providing improved and efficient mechanical tooth cleaning actions thereby. B), When compared with a plain tube-like chew with smooth external surface and in identical material thickness, its corrugated structure/texture provides better stiffness that facilitates its maintaining the original pipe structure after traveling in packages. C), Its corrugated structured/texture provides better stiffness that help it to maintain the original pipe structure and corrugated texture after being gnawed thus providing extended tooth cleaning longevity. Corrugated structure/texture enhances pipe stiffness and absorbs external pressure. D), Compared with a plain tube-like chew with smooth exterior surface and identical material thickness, it provides a visually “thicker” treat to consumers and thus potentially material-saving. Traditional/Natural Tracheas (dehydrated tracheas) chews or esophagus chews, as a kind of natural chews, received well by dogs and consumers, are made of a Natural Part (or a naturally occurring material, or a natural organ), a natural trachea (esophagus) part of animals, especially from bovine species, with alternating ridges and grooves extending substantially latitudinally on its surface approximately perpendicular to the centerline of the chew. The Natural Trachea chew (or esophagus chew) may be in a shape very much resembling or similar to aforementioned corrugated pipe. The similarities or some characteristics (features/properties) in common between a Natural Trachea chew and a Corrugated Pipe may include: A), both the Natural Trachea chew (or esophagus chew) and Corrugated Pipe are in a similar tube/pipe form; B), both the Natural Trachea chew (or esophagus chew) and Corrugated Pipe have a series of latitudinal ridges and grooves running/extending on the surface. These ridges and grooves of the Natural Trachea chews (or esophagus chew) may be created by the existence of cartilage rings or grease parts creating ring-shaped raised parts from the surface. Generally, to make a trachea chew, a trachea is removed from an animal (especially a bovine species), cleaned and then dehydrated by for example heating or freeze-drying process. These dehydrated trachea products enjoy providing favorable benefits to dogs such as inherent content of health-improving materials of glucosamine and chondroitin, long durability for chewing, removing tartar and plaque and good palatability. For dog's healthy feed concerns, when most consumers think of a trachea chew (or esophagus chew), a favorable benefit of healthy joint supporting comes into their mind. Some natural dehydrated trachea chew product (or esophagus chew product) may present small spaces between ridges and grooves caused by low ridge height (groove depth) and/or small distances between a ridge and a groove and/or low groove width. Some grooves may have very small depths. The series of alternating ridges and grooves of some trachea chews may have inhomogeneous ridges and grooves through the chew. And the tube form of the chew may be inhomogeneous through the length.

Some of the composite chews on the market, extruded vegetable dental chews, may simply have ridges extending lengthwise along the surface (it should be noted that these extruded vegetable dental chews do not provide a chew formed from corrugated sheet material). The ridges of these pet chews run/extend longitudinally along the treat surface, which is completely different from the ridge/groove configurations that a corrugated pipe or trachea (esophagus) chew provides. These extruded vegetable dental chews generally are extruded ones processed by an extruder, which is shaped by an extruder die with a round opening with ridge/groove profile. Due to the nature of this specific extrusion process, it can only create an object in a two-dimensional form continuous in length, which results in that it can only generate longitudinal ridges/grooves along the chew body. These composite extruded vegetable dental chews with longitudinal ridges/grooves parts may not be adapted to dog tooth alignments while being bitten widthwise by a dog, so that they may fail to benefit the contact between dog tooth and the chew similarly. These composite extruded vegetable dental chews may include their inability to produce favorable expectation (on joint health benefit) or association with traditional (dehydrated) trachea chew from consumers without their investigating the exact product ingredient statements or claims on the labeling, due to their longitudinal ridge and groove configurations. These composite extruded vegetable dental chews with longitudinal ridges/grooves do not include the materials as a natural source of glucosamine/chondroitin (such as bovine tendon, lamb trachea, esophagus, shark cartilage, crab shell and chicken cartilage) or (added) glucosamine/chondroitin chemicals in their formula that provides joint health benefits to dogs.

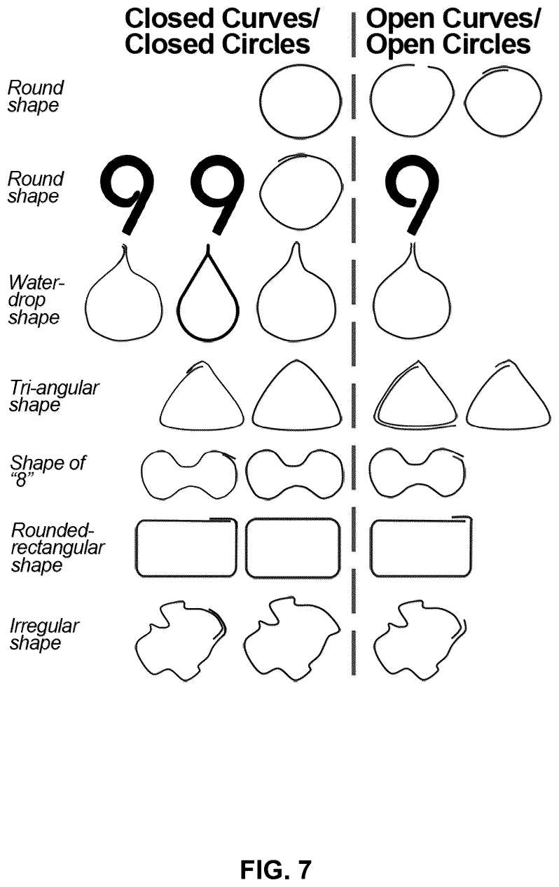

As shown in FIG. 7, various cross-section shape examples that a tubular composite-material component of an edible pet chew with a series of alternating ridges and grooves running/extending (latitudinally) on the surface according to embodiments of the present disclosure may present are grouped into two categories: group 1, closed curves or closed circles; group 2, open curves or open circles. The ones on the left of the dotted line fall into group 1 and the ones on the right, group 2.

As shown in FIG. 8, various longitudinal-section shape examples that a tubular composite-material component of an edible pet chew with a series of alternating ridges and grooves running/extending latitudinally on the surface according to embodiments of the present disclosure may present are illustrated therein, which represent various pet chew designs. Component 0800A of a pet chew has rounded ridge tops, and component 0800B of a pet chew has pointed-edge ridge tops. Component 0800C of a pet chew looking like waves is formed form a curved/rolled corrugated sheet material. Component 0800D of a pet chew has fairly flat ridges tops. Component 0800E of a pet chew has in-homogeneous ridge and groove shapes, dimensions and specifications whose height/depth go in-homogeneous, in which ridge 0801, 0802, and 0803 have different shapes and heights and groove 0804, 0805, and 0806 have different shapes and depths. Component 0800F of a pet chew refers to a longitudinal-section of a helical tubular pet chew.

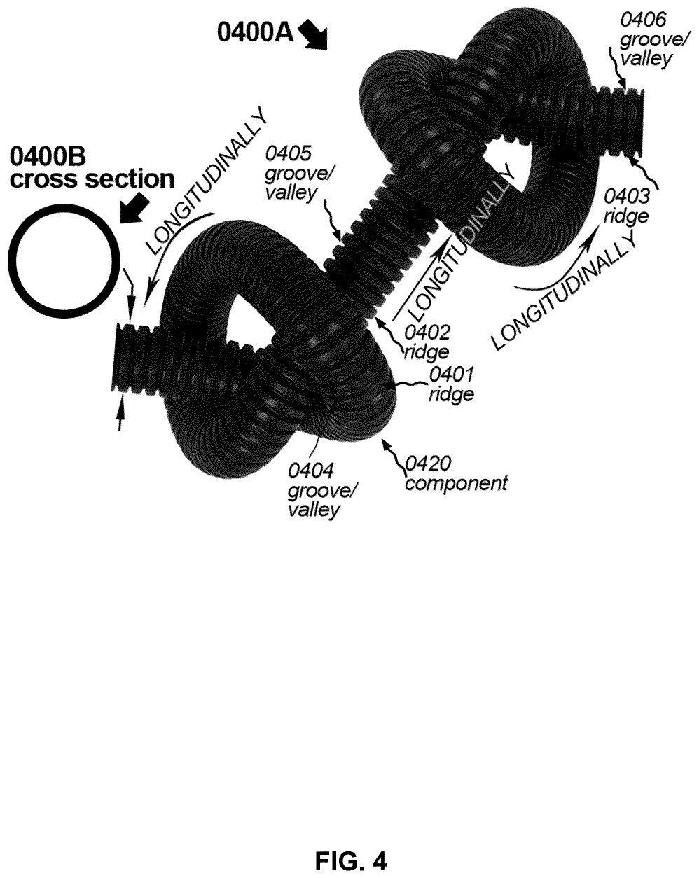

In at least one embodiment, the tubular composite-material component approximates or imitates the shape, and/or profile, and/or structure, and/or form, and/or appearance and/or texture of a Corrugated Pipe or a Trachea chew (or esophagus chew) alternatively. Some pet chews in this embodiment approximating the shape of a Trachea chew may have inhomogeneous ridge/groove specifications or configurations in the aspect of oral cleaning action. Natural dehydrated trachea chew product (or esophagus chew product) may present small spaces between ridges and grooves caused by low ridges height (groove depth) and/or small distances between a ridge and groove and/or low groove width. Some grooves may provide very small depths. The ridge/groove specifications or configurations that some pet chews in this embodiment approximating the shape of a regular Corrugated Pipe may provide are homogeneous with the qualities such as ridge height, and spaces and distance between a ridge and a groove. Some pet chews in this embodiment approximating a Trachea chew having a series of alternating ridges and grooves may have inhomogeneous ridges and grooves through the chew. And the tube form through the length of the pet chews may be inhomogeneous. With inhomogeneous ridges and grooves, the pet chews approximating the shape of a Trachea chew may involve more difficult and complicated production than the ones approximating the shape of a Corrugated Pipe. Refer to FIG. 4, Pet Chew 0400A is made of a tubular composite-material Component 0420 with a series of alternating ridges and grooves running/extending on the surface, approximating the shape of a corrugated pipe or trachea chew. The tubular composite-material Component 0420 may initially be in a round tube form with a cross-section shape of a circle whose ridges and grooves are parallel to each other and thereafter be knotted by hand into a knotted bone form before being hardened into final product. Ridges 0401/0402/0403 are three ridge examples of the series of the ridges. Grooves 0404/0405/0406 are three groove (valley) examples of the series of grooves (valleys). After the knotting step, some of its ridges may be bent out of shape, resulting in the ridges and grooves that may generally (not completely though) run parallel to each other. Component 0420 may have a cross-section shape 0400B of a circle.

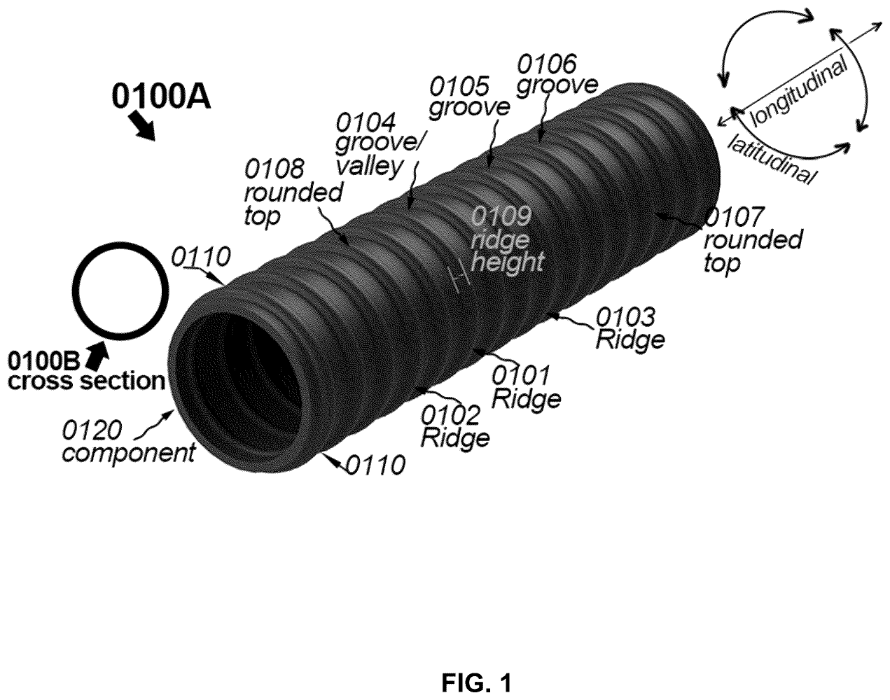

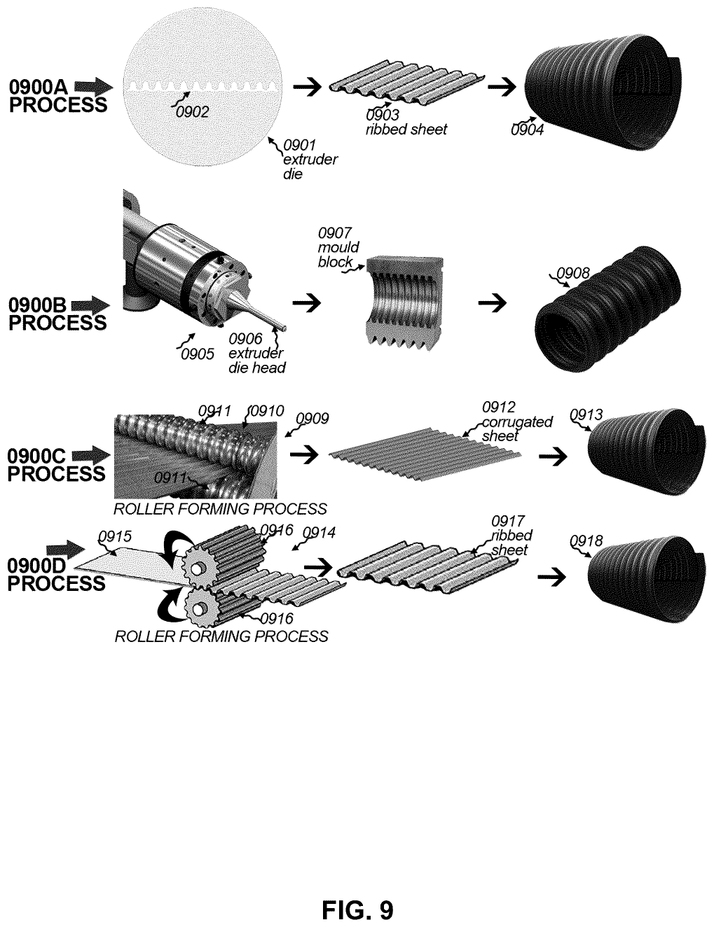

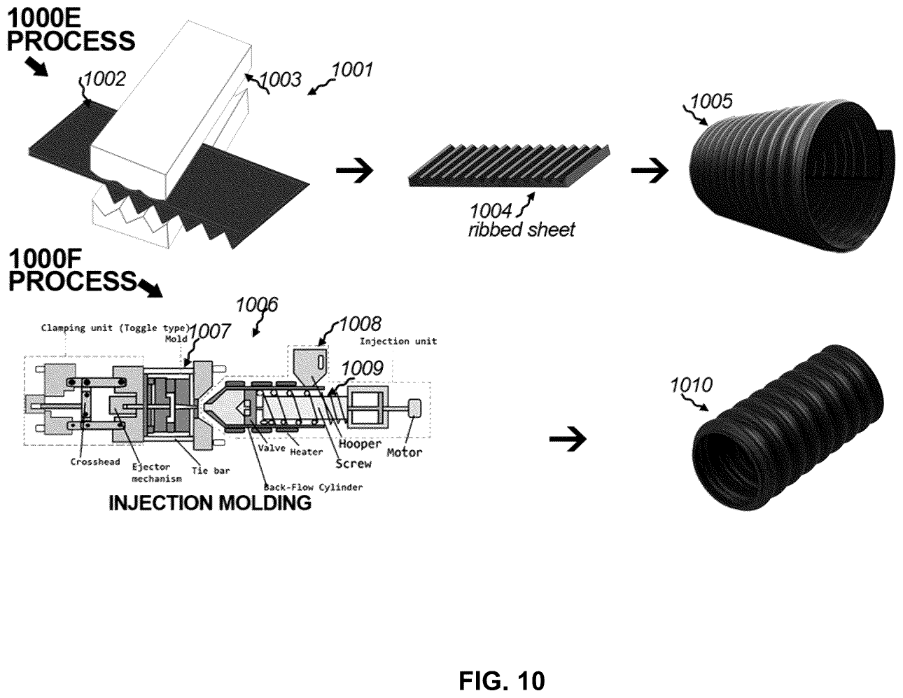

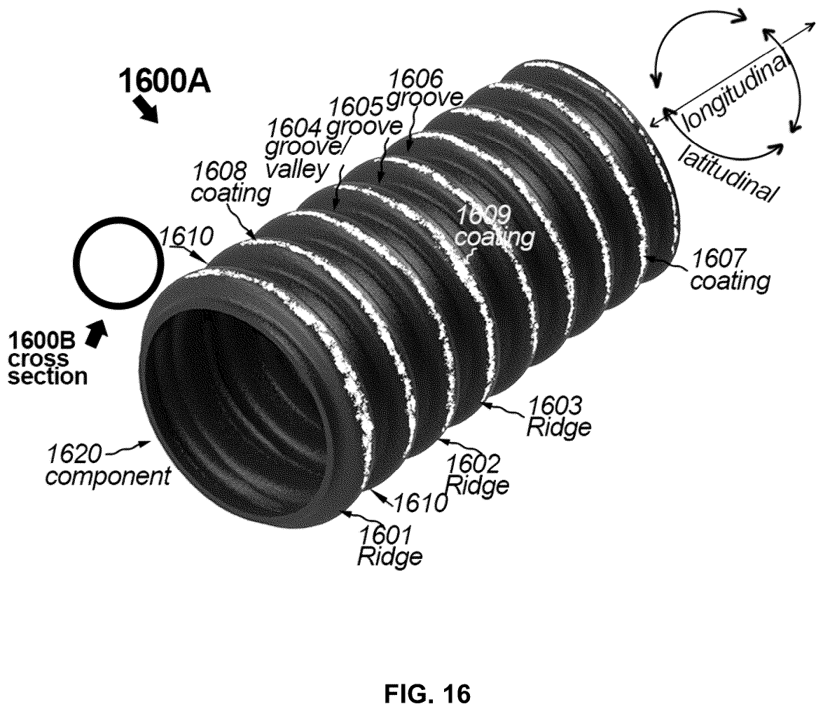

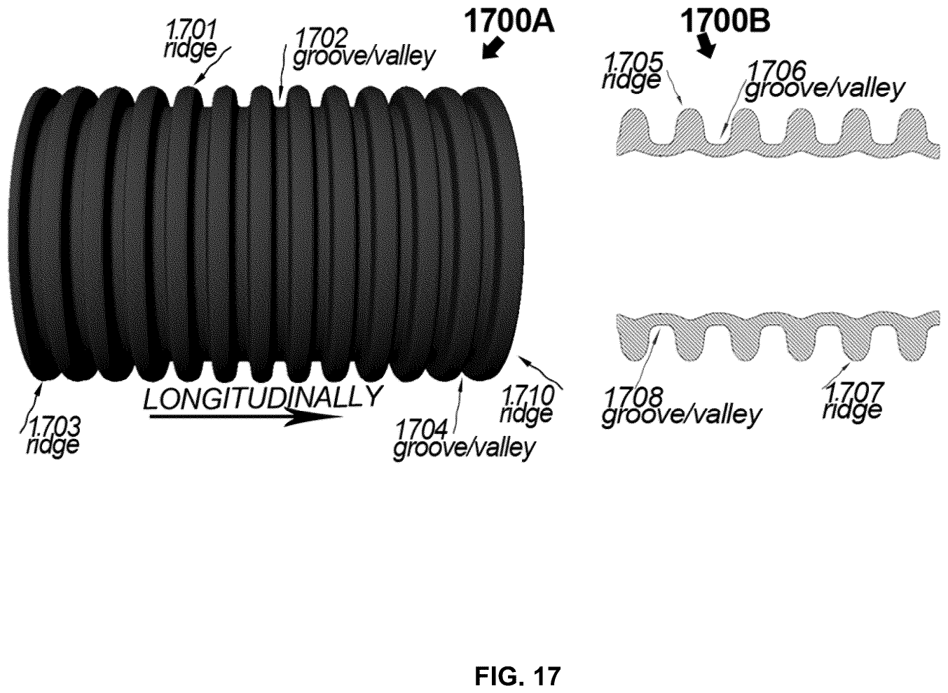

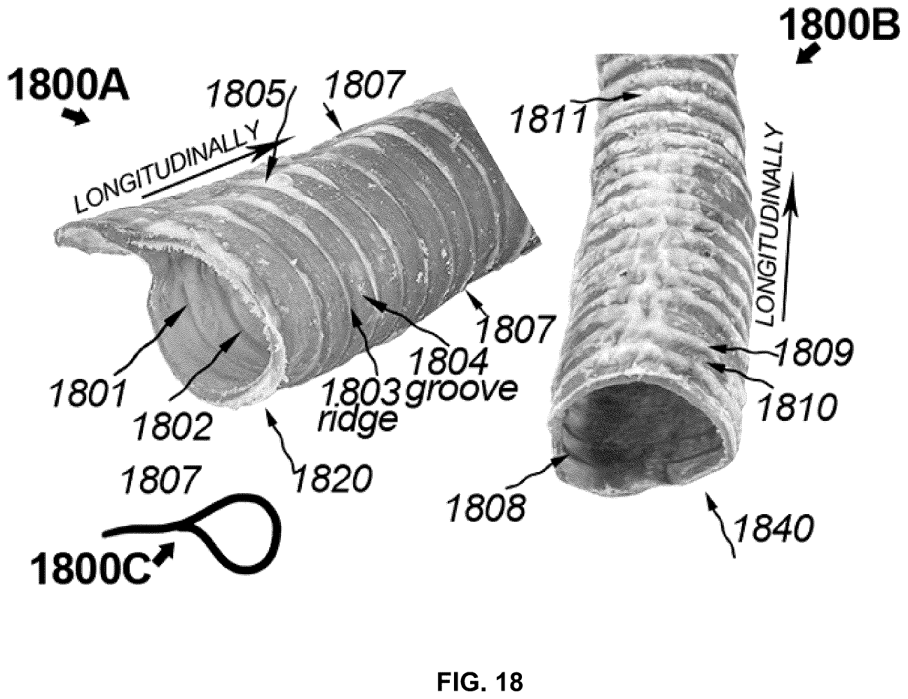

Refer to FIG. 1. The edible Pet Chew 0100A has a tubular composite-material Component 0120 in a Corrugated-pipe shape with a series of alternating ridges (ridge examples 0101/0102/0103) and grooves (groove examples 0104/0105/0106) running/extending latitudinally on the surface. A cross-section shape 0100B of Pet Chew 0100A is a circle obtained at 0110. The ridges in a shape of closed-circle having rounded tops (examples of the rounded tops are 0107 and 0108) run parallel to each other. Ridge Height 0109 of Ridge 0103 is about 6 mm. Groove 0104 extends latitudinally between Ridge 0102 and Ridge 0103, in which the depth of 0104 is substantially equal to the average heights of 0102 and 0103. As illustrated in FIG. 17, Pet Chew 1700A has a tubular composite-material Component 1710 in a corrugated-pipe shape with a series of alternating ridges (ridge examples 1701/1703) and grooves (groove examples 1702/1704) running/extending latitudinally on the surface. Longitudinal view 1700B indicates a series of ridges and grooves (ridges 1705/1707 are ridge examples and grooves 1706/1708 are groove examples). As shown in FIG. 18, pet chew 1800A has a tubular composite-material Component 1820 in a trachea chew shape with a series of alternating ridges (ridge example 1803) and grooves (groove example 1804) running/extending latitudinally on the external surface. Some additional ridges (ridge examples 1801/1820) extend latitudinally on the internal surface of Component 1820, which may imitate cartilage rings that a trachea chew may have. Coating 1805 is an example of a number of coatings spread onto the surface of pet chew 1800A. Cross-section view 1800C shows a water-drop shape, obtained from point 1807 of Component 1820. Pet chew 1800B has a tubular composite-material Component 1840 in a trachea chew shape with a round shaped cross-section outline and with a series of latitudinal alternating ridges (ridge example 1809) and grooves (groove example 1810) on the outside surface. Some additional ridges (ridge example 1808) extend latitudinally on the inside surface of Component 1840. Coating 1811 is an example of a number of coating materials spread onto the surface of pet chew 1800B. The longitudinal-section view 0800A as shown in FIG. 8 refers to a part of longitudinal-section of tubular composite-material Component 0120. Component 0120 is formed from a composite material formulated as required or as desired. Component 0120 may be formed by an injection molding process (refer to the Process 1000F from FIG. 10). Alternatively, Component 0120 may be formed in a process that a composite material is prepared, fed to an extruder, extruded and then is molded by a running corrugation mold block chain in the aid of vacuum or blowing treatment to take a series of alternating (latitudinal) ridges and grooves on the surface as soon as it leaves the long thin extruder die head (refer to the Process (refer to the Process 0900B from FIG. 9). Refer to FIG. 16. The edible Pet Chew 1600A has a tubular composite-material Component 1620 in a Trachea chew shape with a series of alternating ridges (ridge examples 1601/1602/1603) and grooves (groove examples 1604/1605/1606) running/extending latitudinally on the surface. A cross-section shape 1600B of Component 1620 is a circle obtained at 1610. The ridges in a shape of closed-circle run parallel to each other. Groove 1604 extends latitudinally between Ridge 1602 and Ridge 1603, in which the depth of 1604 is substantially equal to the average heights of 1602 and 1603. The spray coating materials (such as coating 1607/1608/1609) are sprayed over the upper parts of the surfaces of the nine ridges, which may imitate the appearance of grease parts existing on the surface of a natural trachea chew. Component 1620 is formed from a composite material formulated as required or as desired.

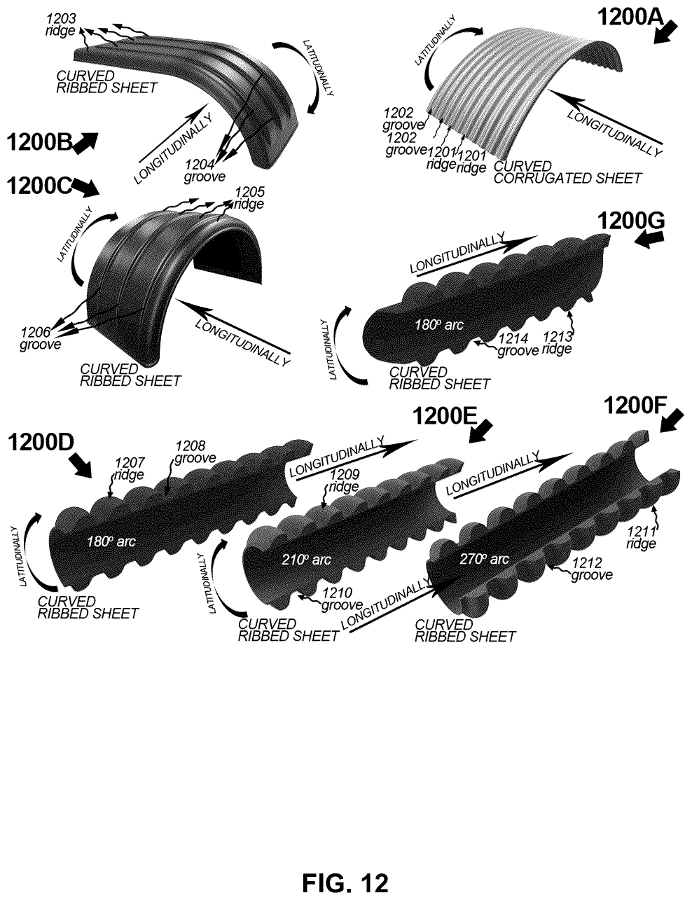

In some embodiments of the present disclosure, it is to provide an edible pet chew including a corrugated-pipe-shaped or trachea-shaped Tubular (composite-material) component/member formed from a (artificial) composite material including a series of alternating (latitudinal) ridges and grooves running (approximately) parallel to each other on its exterior surface approximately perpendicular to the (longitudinal) centerline (longest axis) of the tubular component/member. The cross-section shape of the Tubular component may be various as desired. The cross-section shape (cross-section perpendicular to the longitudinal centerline of the component and obtained at various point of the length) of the Tubular component may be a closed curve (usually a closed circle) or alternatively an open curve (usually an open circle). The tubular component/member may be formed in a way that an initially-flat extruded corrugated-sheet material (or initially-flat extruded ribbed-sheet material) is prepared and then rolled up into a tube with a series of alternating ridges and grooves running (approximately) parallel to each other on its exterior surface latitudinally (refer to the Process 0900A from FIG. 9). Or, it may be formed in a way that an initial sheet material (the sheet material may be formed by extrusion process) is formed into a corrugated-sheet material (or ribbed-sheet material) by for example roller forming process having a series of alternating ridges and grooves on the surface and then the corrugated-sheet material (or ribbed-sheet material) is rolled up into a tube with a series of alternating ridges and grooves running (approximately) parallel to each other on its exterior surface latitudinally (refer to the Process 0900C or Process 0900D from FIG. 9). Or, it may be alternatively formed in a way that a composite material is prepared, fed to an extruder, extruded and then is molded by a running corrugation mold block chain in the aid of vacuum or blowing treatment to take a series of alternating (latitudinal) ridges and grooves on the surface as soon as it leaves the long thin extruder die head (refer to the Process (refer to the Process 0900B from FIG. 9). Or, it may be alternatively formed by an injection-molding process, which creates a hollow corrugated-pipe-shaped or trachea-shaped Tubular composite-material component/member with a series of alternating (latitudinal) ridges and grooves on the surface (refer to the Process 1000F from FIG. 10). The aforementioned ridges may be in an O-shape (complete circle or closed circle) or a C-shape (incomplete circle or open circle). The aforementioned ridges may be in a closed-curve shape or an open-curve shape. In some embodiments of this aspect, the aforementioned tubular component is divided into plural curved corrugated sheet pieces or plural curved ribbed sheet pieces, of which every single piece can individually serve as a pet chew or a pet chew component. Each of the curved corrugated sheet pieces or the curved ribbed sheet pieces has alternating ridges and grooves approximately parallel to each other running/extending latitudinally on the surface and a cross-section shape of the curved corrugated sheet piece or the curved ribbed sheet piece is a curve or an arc. A pet chew (component) formed from the curved corrugated sheet piece or the curved ribbed sheet piece may approximate or imitate the shape of a kind of “trachea segment” chew (or trachea chip chew) that is formed from a portion/segment of natural trachea rather than from a complete tube-shaped trachea which is served in a curved thin piece form with a cross-section shape of an arc/curve (or Semicircle). Refer to FIG. 12. Pet Chew 1200A is formed from a curved-Corrugated-Sheet piece material with a cross-section shape of arc/curve. Pet Chew 1200B is formed from a curved-Ribbed-Sheet piece material with a cross-section shape of a curve. Pet Chew 1200C is formed from a curved-Ribbed-Sheet piece material with a cross-section shape of arc/curve. Pet Chews 1200D, 1200E, 1200F and 1200G are formed from a long curved-Ribbed-Sheet piece material with a cross-section shape of an arc (180-degree-central-angled arc for 1200D/1200G, 210-degree arc for 1200E and 270-degree arc for 1200F).

In one exemplary embodiment, the edible pet chew (pet treat) includes a Corrugated-Pipe-shaped (or trachea chew shaped) composite-material component/member with a series of alternating (latitudinal) ridges and grooves on its surface, where the profile of the ridge tops is rounded (or curved), which may be more comfortably manipulated in a dog's mouth in addition to providing an aesthetically pleasing appearance. In addition, the rounded (or curved) tops of the ridges may guide a dog tooth to a groove area next to a ridge when a dog bites on it. In the fashion, it may improve the contact between a dog tooth and the chew. For example, refer to FIG. 1, Tops 0107 and 0108 from Pet Chew 0100A refer to rounded tops of the ridges. And Pet Chews 0200C/0200D/0200E/0200F from FIGS. 2 and 0800A/0800C/0800F from FIG. 8 also have a series of ridges with rounded tops.

In one exemplary embodiment, the edible pet chew (pet treat) includes a Corrugated-Pipe-shaped (or trachea chew shaped) composite-material component/member with a series of alternating (latitudinal) ridges and grooves on its surface, where the ridges have a curved surface in favor of dog's mouth work while chewing in addition to providing an aesthetically pleasing appearance. In addition, the curved surfaces of the ridges may guide a dog tooth to the groove area next to the ridge when a dog bites on it. Thus, it may improve the contact between a dog tooth and the chew.

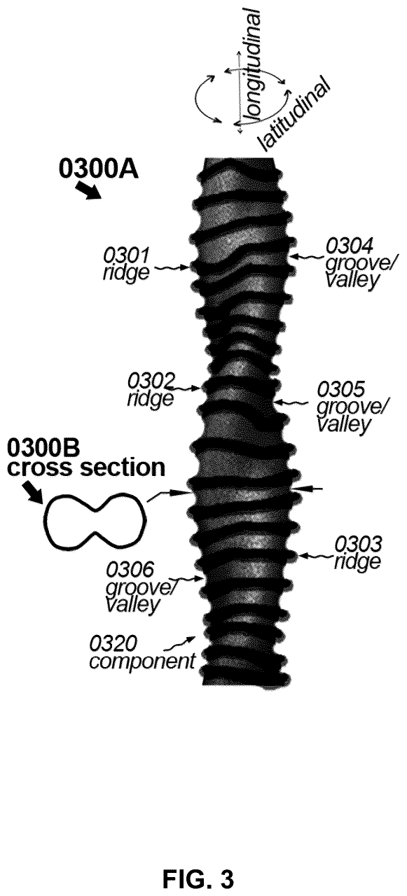

In an embodiment in this aspect of the present disclosure, an edible pet chew includes a tubular component with a series of alternating ridges and grooves (approximately) parallel to each other running/extending latitudinally on the surface, in which the tubular component is manipulated (such as twisting, knotting, curving or shaping by hand or machine) into a final product shape as desired such as a shape of twisted tube, knotted bone, tube ring, braids (braiding at least two separate similar tubular components together), pretzel, dumbbell (including two edible doughs strung on the tubular component), kabob (including three edible doughs strung on the tubular component), spiral, etc. It is foreseen that the aforementioned tubular component that may initially be in an approximately-straight tube form may be shaped by any pre-determined method into any other final product shapes according to desire. Refer to FIG. 3, Pet Chew 0300A is made of a tubular Component 0320 with a series of alternating ridges and grooves. The tubular Component 0320 may initially be in a round tube form with a cross-section shape of a circle whose ridges and grooves are parallel to each other and later may be twisted into a twisted tube form. Ridges 0301/0302/0303 are three ridge examples of the series of the ridges. Grooves 0304/0305/0306 are three groove (valley) examples of the series of grooves (valleys). After the twisting step, some of its ridges may be bent out of shape, in which the ridges generally may still run approximately parallel to each other, but a few of the ridges may not. Component 0320 may have a cross-section shape 0300B of an Arabic number “8”. As illustrated in FIG. 4, Pet Chew 0400A is made of a tubular Component 0420 with a series of alternating ridges (such as ridges 0401/0402/0403) and grooves (such as grooves 0404/0405/0406) running/extending latitudinally on the surface, in a knotted-bone final product shape.

In some embodiments in this aspect of the present disclosure, an edible pet chew is provided including a tube-shaped (or pipe-shaped) component made of a (artificial) composite material with a series of alternating ridges and grooves (approximately) parallel to each other on the surface of it. The alternating ridges and grooves run/extend latitudinally on the surface of the tube-shaped component. In at least one embodiment, the alternating ridges and grooves are approximately perpendicular to the (longitudinal) centerline (longest axis) of the tube-shaped component. In at least one embodiment, the tube-shaped (or pipe-shaped) component imitates the shape or appearance of a corrugated pipe or (dehydrated) trachea chew (or esophagus chew).

In an embodiment in this aspect of the present disclosure, the edible pet chew further includes an additional edible material as a second component assembled with the first component, the aforementioned tubular Corrugated-Pipe-shaped (or trachea-chew-shaped) component. In an embodiment, the additional edible material component is wrapped in the tubular Corrugated-Pipe-shaped (or trachea-chew-shaped) component. In an embodiment, the additional edible material component is a porous material (typically formed from a plant-based material) wrapped in the tubular Corrugated-Pipe-shaped (or trachea-chew-shaped) component. In an embodiment, the additional edible material component wraps the tubular Corrugated-Pipe-shaped (or trachea-chew-shaped) component. In an embodiment, the additional edible material component and the tubular Corrugated-Pipe-shaped (or trachea-chew-shaped) component are assembled in a relationship that the first and second component form alternating layers in that assembly. In some embodiments, the additional edible material is a naturally-Glucosamine/Chondroitin-rich material or a naturally-cartilage-rich material, such as swine tendon, turkey cartilage, beef trachea and beef lung. In an embodiment, the additional edible material is an animal cartilage material such as beef cartilage, chicken cartilage and swine cartilage. In an embodiment, the additional edible material is a trachea (or an esophagus) material. In an embodiment, the additional edible materials are coating materials (or colorant materials) that spread (or are sprayed) onto the upper part of the surfaces of the ridges of the tubular Corrugated-Pipe-shaped (or trachea-chew-shaped) component, which may serve as an imitation against grease part on the surface of a Trachea chew. The coating material spread (or sprayed) onto the tubular Corrugated-Pipe-shaped (or trachea-chew-shaped) component may appear visually distinctive from it. As shown in FIG. 16, each of the nine ridges on Pet Chew 1600A has coating materials sprayed around the upper part of it, looking like a distinctive ring.

When comparing a tubular chew with a series of alternating longitudinal ridges/grooves on the surface (the former) and the one with a series of alternating latitudinal ridges/grooves on the surface (the latter), several benefits that the latter may provide may include the follows: A), The grooves running/extending on the surface of the latter may facilitate the breakage into a shorter chew by a dog owner as desired while feeding to a smaller sized dog. B), It may be able to adapt to dog tooth alignments while being bitten widthwise by a dog, so that it may benefit the contact between dog tooth and the chew similarly. C), It may provide natural trachea chew imitation, but the former may not be able to. D), It may produce favorable expectation (on joint health benefit) or association with natural trachea chews from consumers without their investigating the exact product ingredient statement or claims on the labeling, thanks to its latitudinal ridge/groove structures.

In yet another aspect of the present disclosure, an edible pet chew (pet treat) includes a tubular Trachea-shaped (composite-material) component made of a (artificial) composite material with a series of alternating (latitudinal) ridges and grooves (approximately) parallel to each other running/extending (latitudinally) on the surface. In at least one embodiment, the ridges and grooves are approximately perpendicular to the (longitudinal) centerline (longest axis) of the tubular Trachea-shaped component. In at least one embodiment, the aforementioned “series of alternating ridges and grooves” includes at least three ridges and two grooves. Preferably, the average height of the ridges is at least 0.5 mm (more preferably at least 1 mm), or the average depth of the grooves is at least 0.5 mm (more preferably at least 1 mm). In some embodiments, the length of a ridge is equivalent to at least 50% of the circumference of the material where it runs/extends on. In some preferred embodiments, the length of the tubular Trachea-shaped component that the ridges and grooves together extend on accounts for at least 50% of the entire length of the tubular Trachea-shaped component. In some preferred embodiments, the area that the ridges and grooves together cover accounts for at least 50% of the total area of the exterior surface of the tubular Trachea-shaped component.

In yet another aspect of the present disclosure, an edible pet chew (pet treat) includes a Corrugated-Pipe-shaped tubular composite-material component/member made of a (artificial) composite material with Helical (spiral) ridge(s) and groove(s) like a screw thread running/extending helically on its surface along the body. Preferably, the average height of the ridge(s) or thread(s) is at least 0.5 mm (more preferably at least 1 mm), or the average depth of the groove(s) is at least 0.5 mm (more preferably at least 1 mm). In some preferred embodiments in this aspect, the Corrugated-Pipe-shaped tubular composite-material component is formed from a plant-based (vegetable-based) material. In an embodiment, the aforementioned plant-based material includes at least 20% plant (vegetable) ingredient by weight in formula. In yet another embodiment, the aforementioned plant-based material includes at least 40% plant (vegetable) ingredient by weight in formula. In yet some other embodiments in this aspect, the Corrugated-Pipe-shaped tubular composite-material component is formed from an animal ingredient-based material. In an embodiment, the aforementioned animal ingredient-based material includes substantially at least 10% animal ingredient(s) by weight and 5%-49.9% plant ingredient by weight in formula. In yet some other embodiments in this aspect, the Corrugated-pipe-shaped tubular composite-material component is formed from an animal hide-based material. In some embodiments, the Corrugated-Pipe-shaped tubular composite-material component/member of the present disclosure in this aspect includes Glucosamine and/or Chondroitin (chemical, or compound, or molecule) in it, in which the Glucosamine/Chondroitin may be introduced to the composition of the composite material by directly applying a synthetic Glucosamine/Chondroitin supplement or Glucosamine/Chondroitin supplement substance obtained by extraction and/or chemical process (examples include glucosamine sulfate, glucosamine hydrochloride (HCL), N-acetyl-glucosamine or MSM glucosamine, glucosamine chondroitin, glucosamine chondroitin sulfate, glucosamine chondroitin MSM, chondroitin sulfate, chondroitin sulfate sodium and chondroitin hydrochloride), or by applying a naturally-Glucosamine/Chondroitin-rich animal material such as cartilage, trachea, esophagus and tendon or naturally-cartilage-rich animal material such as animal ear, trachea and esophagus.

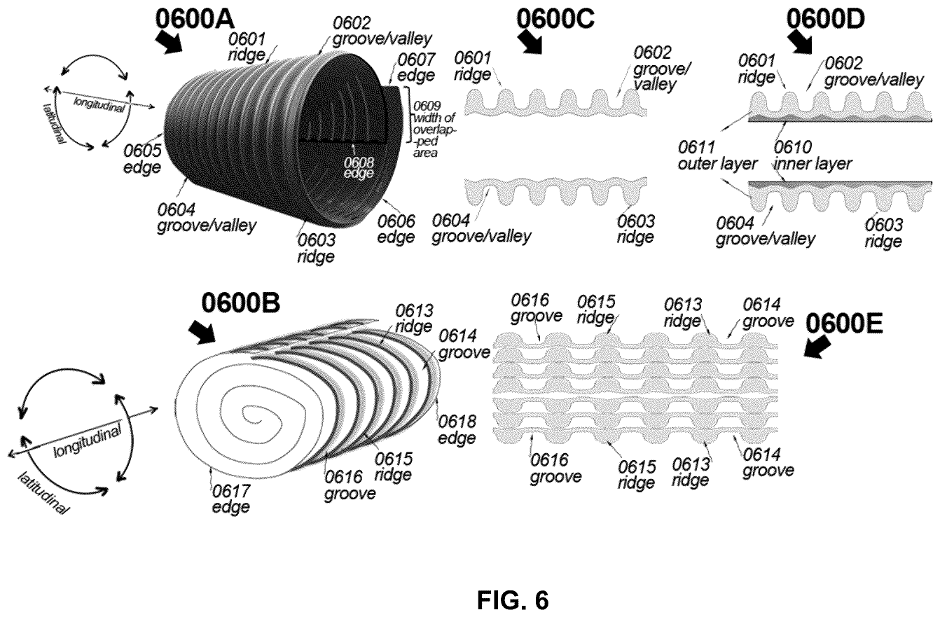

In an aspect of the present disclosure, an edible pet chew includes a curved “corrugated sheet” or a curved “ribbed sheet” (that is curved to form a tube shape or a hollow cylindrical shape) component in a tube shape or hollow cylindrical shape made of composite/composition material. In at least one embodiment, the cross-section outline shape of the curved “corrugated sheet” or the curved “ribbed sheet” is a closed curve. As shown in FIG. 8, various longitudinal-section shape examples that a pet chew formed from a curved “corrugated sheet” or curved “ribbed sheet” component with a series of alternating ridges and grooves running/extending latitudinally on the surface according to embodiments of the present disclosure may present are illustrated therein. In at least one embodiment, the cross-section outline shape of the curved “corrugated sheet” or the curved “ribbed sheet” is an open curve alternatively. In at least one embodiment, there is a series of alternating ridges and grooves (approximately) parallel to each other on the surface of it (or alternatively Helical ridge(s) and groove(s) running/extending helically on its surface like a screw thread). In at least one embodiment, the aforementioned “series of alternating ridges and grooves” includes at least three ridges and two grooves. The aforementioned curved corrugated sheet or curved ribbed sheet may initially be in a substantially rectangular shape before being curved. As a method to form the curved “corrugated sheet” or curved “ribbed sheet” into a tube form, a substantially rectangular “corrugated sheet” or “ribbed sheet” material is curved or bent by curving two parallel edges of the four by hand or machine so as to have other two parallel edges meet, join with or overlap each other (the width of the overlapped area could be in any size such as a size of about 1/20, 1/15 and 1/10 of the length of the curved parallel edges). In at least one embodiment, the alternating ridges and grooves run/extend latitudinally on the surface of the tube-shaped component. In at least one embodiment, the alternating ridges and grooves are approximately perpendicular to the (longitudinal) centerline (longest axis) of the tube-shaped component. In at least one embodiment, the tube-shaped component imitates the shape or appearance of a corrugated pipe or (dehydrated) trachea chew (or esophagus chew). In at least one embodiment, the ridges are in an O-shape (complete circle or closed circle) or a C-shape (incomplete circle or open circle). In at least one embodiment, the ridges are in a closed-curve shape or an open-curve shape. In some embodiments, the curved “corrugated sheet” component (or the curved “ribbed sheet” component) is made of a plant-based (vegetable-based) material, an animal ingredient-based material or an animal hide-based material. In some embodiments, the curved “corrugated sheet” component (or the curved “ribbed sheet” component) is made of a rawhide (animal hide) sheet material, or a reconstituted-rawhide sheet material, or a reconstituted-animal hide sheet material. It is foreseen that the curved “corrugated sheet” component (or the curved “ribbed sheet” component) may be made of other alternative materials as desired other than the aforementioned ones. As illustrated in FIG. 6, Pet Chew 0600A is formed from a curved Ribbed Sheet material with a series of alternating latitudinal ridges (such as ridges 0601/0603) and grooves/valleys (such as grooves 0602/0604) running/extending on the surface. In a method to form Pet Chew 0600A, a flat rectangular ribbed sheet is prepared and then is wrapped about one time by curving two parallel edges 0605/0606 of the four edges of the flat rectangular ribbed sheet as much as to create a small overlapped area 0609 between (near) the other two parallel edges 0607/0608.

In another aspect of the present disclosure, an edible pet chew includes a rolled “corrugated sheet” or rolled “ribbed sheet” (that is rolled up to a cylindrical form or a tubular form) component in a cylinder shape or tube shape made of composite/composition material. As shown in FIG. 8, various longitudinal-section shape examples that a pet chew formed from a rolled “corrugated sheet” or rolled “ribbed sheet” component with a series of alternating ridges and grooves running/extending latitudinally on the surface according to embodiments of the present disclosure may present are illustrated therein. The “corrugated sheet” or “ribbed sheet” may have been wrapped many times around itself so as to form a cylinder or a tube, or may have been wrapped just about one time to form a tube. As a method to form a “corrugated sheet” or “ribbed sheet” into a tube form, a substantially rectangular “corrugated sheet” or “ribbed sheet” material is rolled up by curving two parallel edges of the four by hand or machine so as to have other two parallel edges meet, join with or overlap each other (the width of the overlapped area could be in any size such as a size of about 1/20, 1/15 and 1/10 of the length of the curved parallel edges). In at least one embodiment, there is a series of alternating ridges and grooves (approximately) parallel to each other on the surface of it (or alternatively Helical (spiral) ridge(s) and groove(s) running/extending helically on its surface like a screw thread). In at least one embodiment, the aforementioned “series of alternating ridges and grooves” includes at least three ridges and two grooves. The aforementioned corrugated sheet or ribbed sheet may initially be in a substantially rectangular shape before being rolled. In at least one embodiment, the alternating ridges and grooves run/extend latitudinally on the surface (both ridges and grooves run/extend latitudinally on the surface) of the cylinder-shaped (tube-shaped) component. In at least one embodiment, the alternating ridges and grooves are approximately perpendicular to the (longitudinal) centerline (longest axis) of the cylinder-shaped (tube-shaped) component. In at least one embodiment, the tube-shaped component imitates the shape or appearance of a corrugated pipe or (dehydrated) trachea chew (or esophagus chew). In at least one embodiment, the cylinder-shaped component imitates the shape or appearance of a corrugated pipe or (dehydrated) trachea (or esophagus) but it is not be a hollow object as a corrugated pipe is. In at least one embodiment, the ridges are in an O-shape (complete circle or closed circle) or a C-shape (incomplete circle or open circle). In at least one embodiment, the ridges are in a closed-curve shape or an open-curve shape. In some embodiments, the rolled “corrugated sheet” component (or the rolled “ribbed sheet” component) is made of a plant-based (vegetable-based) material, an animal ingredient-based material or an animal hide-based material. In some embodiments, the rolled “corrugated sheet” component (or the rolled “ribbed sheet” component) is made of a rawhide (animal hide) sheet material, or a reconstituted-rawhide sheet material, or a reconstituted-animal hide sheet material. It is foreseen that the rolled “corrugated sheet” component (or the rolled “ribbed sheet” component) may be made of other alternative materials as desired other than the aforementioned ones.

As illustrated in FIG. 6, Pet Chew 0600A is formed from a rolled Ribbed Sheet material with a series of alternating latitudinal ridges (such as ridges 0601/0603) and grooves/valleys (such as grooves 0602/0604) running/extending on the surface. In a method to form Pet Chew 0600A, a flat rectangular ribbed sheet is prepared and then is wrapped about one time by bending two parallel edges 0605/0606 of the four edges of the flat rectangular ribbed sheet as much as to create a small overlapped area 0609 between (near) the other two parallel edges 0607/0608, in which the width of overlapped area 0609 accounts for about 1/9 of that of the length of edges 0605/0606. In one embodiment, Pet Chew 0600A has a longitudinal-section shape as illustrated by 0600C, which is formed from a single-layered composite material. In yet another embodiment, Pet Chew 0600A has a longitudinal-section shape as illustrated by 0600D which is formed from a two-layered composite material formed from inner layer 0610 and outer layer 0611, of which inner layer 0610 and outer layer 0611 may be similarly formulated or differently formulated.

Again, refer to FIG. 6. Pet Chew 0600B is formed from a rolled Ribbed Sheet material with a series of alternating latitudinal ridges (such as ridges 06013/0615) and grooves/valleys (such as grooves 0614/0616) running/extending on the surface. In a method to form Pet Chew 0600B, a flat rectangular ribbed sheet is prepared and then is wrapped many times around itself by curving two parallel edges 0617/0618 of the four edges of the flat rectangular ribbed sheet to create a pet chew component in a roll form. Pet Chew 0600B has a longitudinal-section view as illustrated by 0600E.

In an embodiment in this aspect of the present disclosure, the edible pet chew further includes an additional edible material as a second component assembled with the first component of rolled corrugated-sheet or rolled ribbed-sheet. In an embodiment, the additional edible material component is wrapped in the rolled corrugated-sheet or rolled ribbed-sheet component. In an embodiment, the additional edible material component is a porous material (typically formed from a plant-based material) wrapped in the rolled corrugated-sheet or rolled ribbed-sheet component. In an embodiment, the additional edible material component wraps the rolled corrugated-sheet or rolled ribbed-sheet component. In an embodiment, the additional edible material component and the rolled corrugated-sheet (or rolled ribbed-sheet component) are assembled in a relationship that the first and second component form alternating layers in that assembly. In an embodiment, the additional edible materials are coating materials (or colorant materials) that spread (or are sprayed) onto (the upper part of) the surfaces of the ridges of the rolled corrugated-sheet or rolled ribbed-sheet component. The coating materials spread (or sprayed) onto the rolled corrugated-sheet or rolled ribbed-sheet component may appear visually distinctive from it.

In yet another aspect of the present disclosure, an edible pet chew includes a rolled “corrugated sheet” or rolled “ribbed sheet” (that is rolled up into a cylinder form or a tubular form) component in a cylinder shape or tube shape made of composite/composition material, where there are a series of alternating ridges and grooves (approximately) parallel to each other running/extending longitudinally on the surface of it. In at least one embodiment, the aforementioned “series of alternating ridges and grooves” includes at least three ridges and two grooves. The “corrugated sheet” or “ribbed sheet” may have been wrapped many times around itself so as to form a cylinder or a tube, or may have been wrapped just about one time to form a tube. In the circumstance that the “corrugated sheet” or “ribbed sheet” is wrapped just about one time to form a tube, it may also be described as the “corrugated sheet” or “ribbed sheet” is curved to form a tube. As a method to form a “corrugated sheet” or “ribbed sheet” into a tube form, a substantially rectangular “corrugated sheet” or “ribbed sheet” material is rolled up by curving two parallel edges of the four by hand or machine so as to have other two parallel edges meet, join with or overlap each other (the width of the overlapped area could be in any size such as a size of about 1/20, 1/15 and 1/10 of the length of the curved parallel edges). The aforementioned corrugated sheet or ribbed sheet may initially be in a substantially rectangular shape before being rolled. In at least one embodiment, the alternating ridges and grooves are approximately parallel to the (longitudinal) centerline (longest axis) of the cylinder-shaped (tube-shaped) component. In some embodiments, the rolled “corrugated sheet” (or the rolled “ribbed sheet” component) is made of a plant-based (vegetable-based) material, an animal ingredient-based material or an animal hide-based material. In some embodiments, the rolled “corrugated sheet” (or the rolled “ribbed sheet” component) is made of a rawhide (animal hide) sheet material, or a reconstituted-rawhide sheet material, or a reconstituted-animal hide sheet material. It is foreseen that the rolled “corrugated sheet” (or the rolled “ribbed sheet” component) may be made of other alternative materials as desired other than the aforementioned ones. Since the aforementioned corrugated sheet or ribbed sheet has longitudinal alternating ridges and grooves, while being wrapped many times into a roll form, the ridges and grooves appearing on one layer of the roll cannot match well the ridges or grooves appearing on another layer under or above it. It creates numerous spaces, pores or holes between the roll layers. Thus, it brings an improved teeth cleaning action benefit to a product developed according to this embodiment with the favorable spaces, pores and holes while a dog's teeth penetrate through the layers during its gnawing activity. Products developed according to this embodiment may provide other benefits. When being formed into a rolled product in a same size and diameter, the corrugated sheet (ribbed sheet) material with longitudinal alternating ridges and grooves may get a lighter weight product and thus use less raw materials than other sheet materials without longitudinal alternating ridges and grooves. Comparing a rolled chew product formed from a corrugated-sheet material and another one in a similar form formed from a ribbed sheet material, the former may provide benefits as follows. A), Since corrugated-sheet material approximates corrugated cardboard that is applied as a main material to make corrugated shipping cartons in packaging industry that is well known to pet chew consumers, an edible pet chew formed from a corrugated-sheet referred herein may provide aesthetically appealing to the consumers, whereas ribbed-sheet material may not work well in this direction. B), The chew product made of a corrugated-sheet material with homogenous material thickness (such as thicknesses 0501/0502 of 0500E and 0503/0504 of 0500F from FIG. 5) may be more easily penetrated by dog tooth while being gnawed than that made of a ribbed-sheet material similarly formulated, in which the former may provide better mechanical tooth cleaning actions. C), When being formed into a pet chew product in the same size, corrugated-sheet material with alternating ridges and grooves may provide a more porous internal structure in the chew. D), When being formed into a pet chew product in the same size, a corrugated-sheet material with alternating ridges and grooves may get an even lighter weight product and thus use less raw material than a ribbed-sheet material similarly formulated.

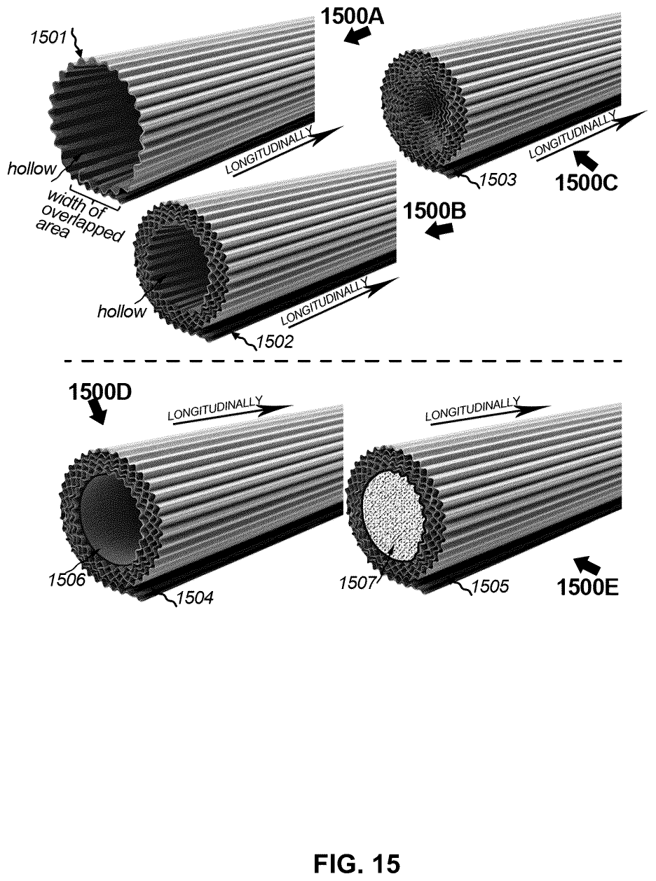

Refer to FIG. 15, some embodiments in the aspect of the present disclosure are illustrated therein. Pet Chew 1500A and 1500B are formed from a Corrugated-Sheet 1501 and 1502 respectively. In a method to provide Pet Chew 1500A (1500B), 1501 (15002) is initially a flat Corrugated-Sheet and thereafter is rolled up into a rolled (or curved) Corrugated-Sheet in a tube form. In yet another alternative method to provide Pet Chew 1500B (1500A), prepare an extruder die with a spiral opening for pet chew 1500B (or open circle opening for pet chew 1500A) formed from a wavy (or zigzag) line; feed a composite material that is employed to make the chew product into the extruder; forming a corrugated-sheet roll by extruding the composite material out. Pet Chew 1500C is formed from a Corrugated-Sheet 1503. In a method to provide Pet Chew 1500C, 1503 is initially a flat Corrugated-Sheet and thereafter wrapped many times around itself into a rolled Corrugated-Sheet in a somewhat solid cylinder form.

In an embodiment in this aspect of the present disclosure, an edible pet chew further includes an additional edible material as a second component assembled with the first component of rolled corrugated-sheet or rolled ribbed-sheet. In an embodiment, the additional edible material component is a tube material (such as an extruded tube formed from a composite material). In an embodiment, the additional edible material component is wrapped in the rolled corrugated-sheet or rolled ribbed-sheet component. In an embodiment, the additional edible material component is a porous material (typically formed from a plant-based material) wrapped in the rolled corrugated-sheet or rolled ribbed-sheet component. In an embodiment, the additional edible material component wraps the rolled corrugated-sheet or rolled ribbed-sheet component. In an embodiment, the additional edible material component and the rolled corrugated-sheet or rolled ribbed-sheet component are assembled in a relationship that the first and second component form alternating layers in that assembly. In an embodiment, the additional edible materials are coating materials that spread (or are sprayed) onto (the upper part of) the surfaces of the ridges of the rolled corrugated-sheet or rolled ribbed-sheet component. The coating materials spread (or sprayed) onto the rolled corrugated-sheet or rolled ribbed-sheet component may appear visually distinctive from it. Pet Chew 1500D is formed from a first component of Rolled Corrugated-Sheet 1504 and a second component of tubular material 1506, in which Rolled Corrugated-Sheet 1504 and tubular material 1506 are assembled together in a relationship that the latter is wrapped about by the former. Pet Chew 1500E is formed from a first component of Rolled Corrugated-Sheet 1505 and a second component of cylindrical material 1507, in which Rolled Corrugated-Sheet 1505 and cylindrical material 1507 are assembled together in a relationship that the latter is wrapped about by the former.

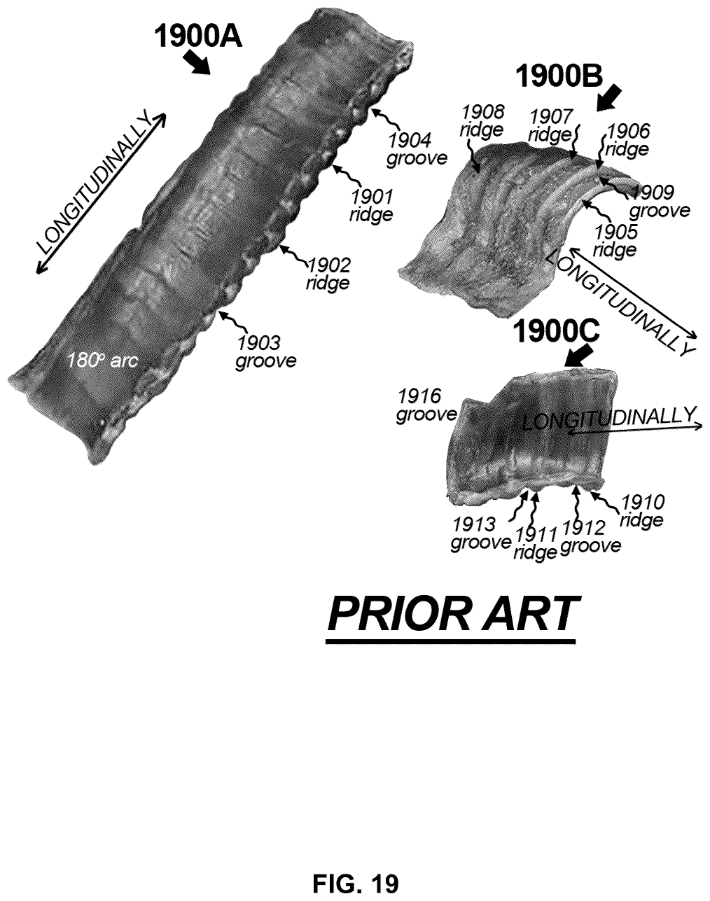

In yet another aspect of the present disclosure, an edible pet chew (pet treat) includes a curved “corrugated sheet” or curved “ribbed sheet” component/member with a cross-section shape of an arc/curve (or especially a cross-section shape of an approximate Semicircle or Open Circle) with a series of (latitudinal) alternating ridges and grooves (approximately) parallel to each other on its exterior surface latitudinally approximately perpendicular to the (longitudinal) centerline (longest axis) of the curved “corrugated sheet” or curved “ribbed sheet” component/member. In at least one embodiment, the aforementioned “series of alternating ridges and grooves” includes at least three ridges and two grooves. In some preferred embodiments, the arc shape of the cross-section of the curved “corrugated sheet” or curved “ribbed sheet” component has a central angle in a range between 90-degree and 360-degree. Preferably, the average height of the ridges is at least 0.5 mm (more preferably at least 1 mm), or the average depth of the grooves is at least 0.5 mm (more preferably at least 1 mm). In some preferred embodiments, the area that the ridges and grooves together cover accounts for at least 50% of the total area of the exterior surface of the curved-corrugated-sheet or curved-ribbed-sheet component. In at least one embodiment, the pet chew approximates or imitates the shape of a kind of “trachea segment” chew (or trachea chip chew) that is formed from a portion/segment of natural trachea rather than from a complete tube-shaped trachea which is served in a curved thin piece form with a cross-section shape of an arc/curve (or Semicircle). As illustrated in FIG. 19, Pet Chews 1900A/1900B/1900C (prior arts) are referred to as some exemplary ones of the aforementioned trachea segment chews (trachea chip chews). Pet Chew 1900A in a long thin curved piece form made of a segment of a bovine trachea, with a series of alternating latitudinal ridges (exemplary ridges 1901 and 1902) and grooves (exemplary grooves 1903 and 1904) running/extending on the surface of the chew. Pet Chews 1900B and 1900C in a curved piece form made of a segment of a bovine trachea, with a series of alternating latitudinal ridges (exemplary ridges 1905/1906/1907/1908 for 1900B and 1910/1911 for 1900C) and grooves (exemplary grooves 1909 for 1900B and 1912/1913 for 1900C) running/extending on the surface of the chew. In at least one embodiment, the cross-section outline shape of the curved “corrugated sheet” component or the curved “ribbed sheet” component is an open curve. The pet chews in this embodiment may as well convey similar dog health benefit expectation or association to consumers as natural trachea chew does. In some embodiments, the curved “corrugated sheet” or curved “ribbed sheet” component is formed from a material including Glucosamine and/or Chondroitin (substance) in it. Alternatively in at least one embodiment, the series of alternating ridges and grooves (approximately) parallel to each other on its exterior surface run/extend longitudinally on the curved “corrugated sheet” or curved “ribbed sheet” component. In some embodiments, the curved “corrugated sheet” component (or the curved “ribbed sheet” component) is made of a plant-based (vegetable-based) material, an animal ingredient-based material or an animal hide-based material. In some embodiments, the curved “corrugated sheet” (or the curved “ribbed sheet” component) is made of a rawhide (animal hide) sheet material, or a reconstituted-rawhide sheet material, or a reconstituted-animal hide sheet material. It is foreseen that the curved “corrugated sheet” component (or the curved “ribbed sheet” component) may be made of other alternative materials as desired other than the aforementioned ones.

In an embodiment in this aspect of the present disclosure, the edible pet chew (pet treat) includes an arc-shaped curved “corrugated sheet” or arc-shaped curved “ribbed sheet” component with a cross-section shape of an arc with a series of (latitudinal) alternating ridges and grooves (approximately) parallel to each other on its exterior surface latitudinally approximately perpendicular to the (longitudinal) centerline (longest axis) of the curved “corrugated sheet” or curved “ribbed sheet” component.

Refer to FIG. 12. Pet Chew 1200A is formed from a curved-Corrugated-Sheet material formed from a composite with a cross-section shape of arc/curve, in which alternating ridges 1201 and grooves 1202 running/extending latitudinally on the surface. Pet Chew 1200B is formed from a curved-Ribbed-Sheet material made of a composite with a cross-section shape of a curve, in which alternating ridges 1203 and grooves 1204 running/extending latitudinally on the surface. Pet Chew 1200C is formed from a curved-Ribbed-Sheet material made of a composite with a cross-section shape of arc/curve, in which alternating ridges 1205 and grooves 1206 running/extending latitudinally on the surface, which may approximate or resemble the shape of a piece of an arc-shaped trachea segment. Pet Chews 1200D, 1200E, 1200F and 1200G are formed from a long curved-Ribbed-Sheet material made of a composite with a cross-section shape of an arc (180-degree-central-angled arc for 1200D/1200G, 210-degree arc for 1200E and 270-degree arc for 1200F), in which alternating ridges (ridges 1207 for 1200D, ridges 1213 for 1200G, ridges 1209 for 1200E and ridges 1211 for 1200F) and grooves (grooves 1208 for 1200D, grooves 1214 for 1200G, grooves 1210 for 1200E and grooves 1212 for 1200F) running/extending latitudinally on the surfaces respectively. Pet Chew 1200D may approximate or resemble the shape of the prior art 1900A from FIG. 19. Pet Chew 1200G has two rounded ends.

In an embodiment in this aspect of the present disclosure, it is to provide an edible pet chew (pet treat) including a curved-corrugated-sheet chip (or piece) component (or a curved-ribbed-sheet chip component) with a series of alternating (latitudinal) ridges and grooves (approximately) parallel to each other on its exterior surface approximately perpendicular to the (longitudinal) centerline of the component. Refer to pet chew 1200A from FIG. 12, an embodiment of a curved-corrugated-sheet chip is provided. Refer to pet chews 1200B/1200C from FIG. 12, two embodiments of a curved-ribbed-sheet chip is provided. In some embodiments, the curved-corrugated-sheet chip (or curved-ribbed-sheet chip) component is formed from a material including Glucosamine and/or Chondroitin (substance) in it. The pet chew in this aspect may as well convey similar dog health benefit expectations or association to consumers as trachea chew does. In some preferred embodiments, the curved-corrugated-sheet chip (or curved-ribbed-sheet chip) component has a length and width in which the length is greater than the width in measurement and the ridges and grooves (approximately) parallel to each other run/extend latitudinally on its exterior surface.

In yet another aspect of the present disclosure, an edible pet chew (pet treat) includes a rawhide sheet (animal hide sheet) tubular component (such as a traditional rawhide sheet tubular component, an animal hide sheet tubular component, a reconstituted-rawhide-sheet tubular component and a reconstituted-animal hide sheet tubular component), in which the tubular component has a series of alternating ridges and grooves (approximately) parallel to each other running/extending on the surface. In some preferred embodiments, the tubular component has a series of alternating (latitudinal) ridges and grooves approximately parallel to each other running/extending latitudinally on the surface. In at least one embodiment, the aforementioned “series of alternating ridges and grooves” includes at least three ridges and two grooves. In at least one embodiment, the aforementioned rawhide sheet (animal hide sheet) tubular component, reconstituted-rawhide-sheet tubular component, or reconstituted-animal hide sheet tubular component is a corrugated-pipe-shaped or trachea-shaped one. Preferably, the average height of the ridges is at least 0.5 mm (more preferably at least 1 mm), or the average depth of the grooves is at least 0.5 mm (more preferably at least 1 mm). In some embodiments, the length of a ridge is equivalent to at least 50% of the circumference of the material where it runs/extends on. In some preferred embodiments, the length of the rawhide sheet tubular component that the ridges and grooves together extend on accounts for at least 50% of the entire length of the rawhide sheet tubular component. In some preferred embodiments, the area that the ridges and grooves together cover accounts for at least 50% of the total area of the exterior surface of the rawhide sheet tubular component. In some preferred embodiments, the edible pet chew including the aforementioned sheet tubular component further has additional Glucosamine and/or Chondroitin (substance) in it. In some embodiments, the additional Glucosamine and/or Chondroitin (substance) is introduced into the component by directly applying a synthetic Glucosamine/Chondroitin supplement or a Glucosamine/Chondroitin supplement substance obtained by extraction and/or chemical process (examples include glucosamine sulfate, glucosamine hydrochloride (HCL), N-acetyl-glucosamine or MSM glucosamine, glucosamine chondroitin, glucosamine chondroitin sulfate, glucosamine chondroitin MSM, chondroitin sulfate, chondroitin sulfate sodium and chondroitin hydrochloride), or by applying naturally-Glucosamine/Chondroitin-rich animal material such as animal cartilage, trachea, esophagus and tendon or naturally-cartilage-rich animal material such as animal ear, trachea and esophagus. In some embodiments, the Glucosamine and/or Chondroitin (substance) is introduced by basting, coating or by soaking process with a material in a solution/paste form that has Glucosamine and/or Chondroitin therein. In yet some embodiments, the Glucosamine and/or Chondroitin (substance) is introduced by additionally employing a second component of naturally-Glucosamine/Chondroitin-rich material such as animal cartilage, trachea, esophagus, tendon, chicken cartilage, beef trachea and beef tendon to be assembled with the first rawhide sheet material component, or by additionally employing a second component of naturally-cartilage-rich animal material such as animal ear, trachea and esophagus to be assembled with the first rawhide sheet material component.

In an embodiment in this aspect of the present disclosure, it is to provide a rawhide pet chew including a (traditional) rawhide sheet (animal hide sheet) tubular component, a reconstituted-rawhide-sheet tubular component, or a reconstituted-animal-hide sheet tubular component, in which the tubular component has a series of alternating ridges and grooves (approximately) parallel to each other running/extending latitudinally on the surface. In some embodiments, the rawhide pet chew further has a joint support or benefitting material such as Glucosamine/Chondroitin in it. In another embodiment of the present disclosure, it is to provide a rawhide pet chew including a corrugated-pipe-shaped or trachea-shaped component made of (traditional) rawhide sheet (animal hide sheet), reconstituted-rawhide-sheet, or reconstituted-animal hide sheet. In some embodiments, the rawhide pet chew including a corrugated-pipe-shaped or trachea-shaped component further has a joint support or benefitting material such as Glucosamine/Chondroitin in it.

In an embodiment of the present disclosure, the rawhide sheet tubular component of an edible pet chew includes two portions, a rawhide sheet material portion and a coating material portion that appears on the surface of the rawhide sheet material portion. In an embodiment of the present disclosure, the rawhide sheet tubular component of an edible pet chew includes two portions, a rawhide sheet material portion and a coating material portion that appears on (the upper part of) the surfaces of the ridges of the rawhide sheet material portion. In yet another embodiment of the present disclosure, the rawhide sheet tubular component of an edible pet chew includes two portions, a rawhide sheet material portion and a basting material portion that appears on the surface of the rawhide sheet material portion. In some embodiments, the aforementioned coating material portion (or basting material portion) has Glucosamine and/or Chondroitin in it, in which the Glucosamine/Chondroitin may be in a form of Glucosamine/Chondroitin chemical that is employed in the coating (basting) material composition, or may come from a naturally-Glucosamine/Chondroitin-rich material that is employed in the coating (basting) material composition, or may come from a naturally-cartilage-rich material that is employed in the coating (basting) material composition.

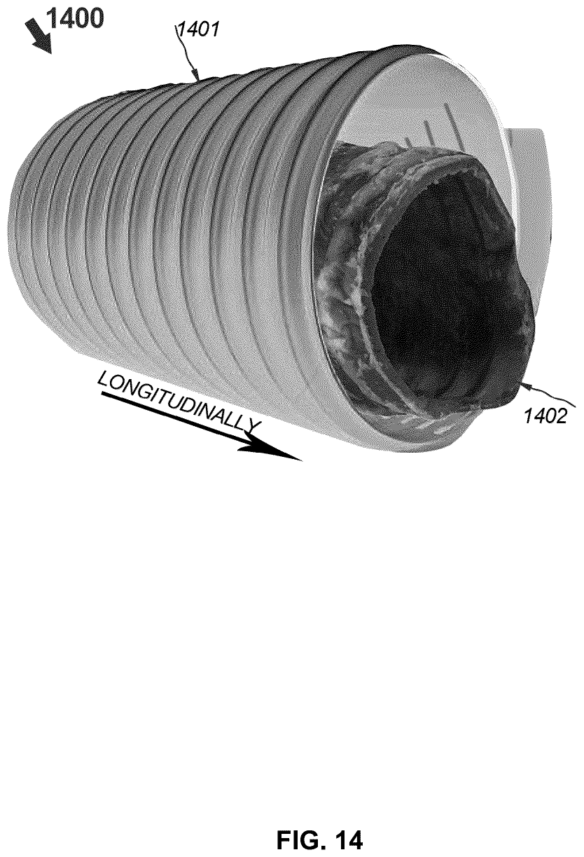

In some embodiments, the rawhide (animal hide) pet chew further includes an additional edible material as a second component which is assembled with the first component of the aforementioned rawhide sheet (animal hide sheet) tubular component (or reconstituted-rawhide sheet tubular component, or reconstituted-animal hide sheet tubular component). In some embodiments, the edible pet chew has an additional edible material component wrapped in by the rawhide sheet (animal hide sheet) tubular component (or reconstituted-rawhide sheet tubular component, or a reconstituted-animal hide sheet tubular component), in which at least a portion of the additional edible material is concealed by the rawhide sheet (animal hide sheet) tubular component (or reconstituted-rawhide sheet tubular component, or a reconstituted-animal hide sheet tubular component). In some embodiments, the additional edible material is a naturally-Glucosamine/Chondroitin-rich material or a naturally-cartilage-rich material, such as swine tendon, turkey cartilage, beef trachea and beef lung. In an embodiment, the additional edible material is an animal cartilage material such as beef cartilage, chicken cartilage and swine cartilage. In an embodiment, the additional edible material is a trachea (or an esophagus) material. As shown in FIG. 14, Pet Chew 1400 has a tube-shaped rawhide sheet component 1401 with a series of alternating ridges and grooves running/extending latitudinally on the surface and an additional trachea 1402 wrapped therein. Rawhide sheet 1401 initially is a flat rawhide sheet and thereafter rolled up into a tube form.

In yet another aspect of the present disclosure, an edible pet chew includes a solid cylinder-shaped component made of a composite material with a series of alternating ridges and grooves (approximately) parallel to each other running/extending latitudinally on the surface (both ridges and grooves run/extend latitudinally on the surface) of it. The alternating ridges and grooves may be approximately perpendicular to the (longitudinal) centerline (longest axis) of the solid cylinder-shaped component. In some embodiments, a ridge and a groove run/extend helically on the surface of the solid cylinder-shaped component like a screw thread. The series of alternating latitudinal ridges and grooves may include at least three ridges and two grooves. The solid cylinder-shaped component may imitate the shape or appearance or surface texture of a corrugated pipe or (dehydrated) trachea chew (or esophagus chew) though it is a solid object. The ridges may be in an O-shape (complete circle or closed circle) or a C-shape (incomplete circle or open circle). The ridges may be in a closed-curve shape or an open-curve shape. In some embodiments, the solid cylinder-shaped component is made of edible thermoplastic material. The solid cylinder-shaped component may be formed from a plant-based material, or an animal ingredient-based material, or an animal hide-based material. In some embodiments, the solid cylinder-shaped component is formed by injection molding, cast molding, compression molding process or roller forming process.

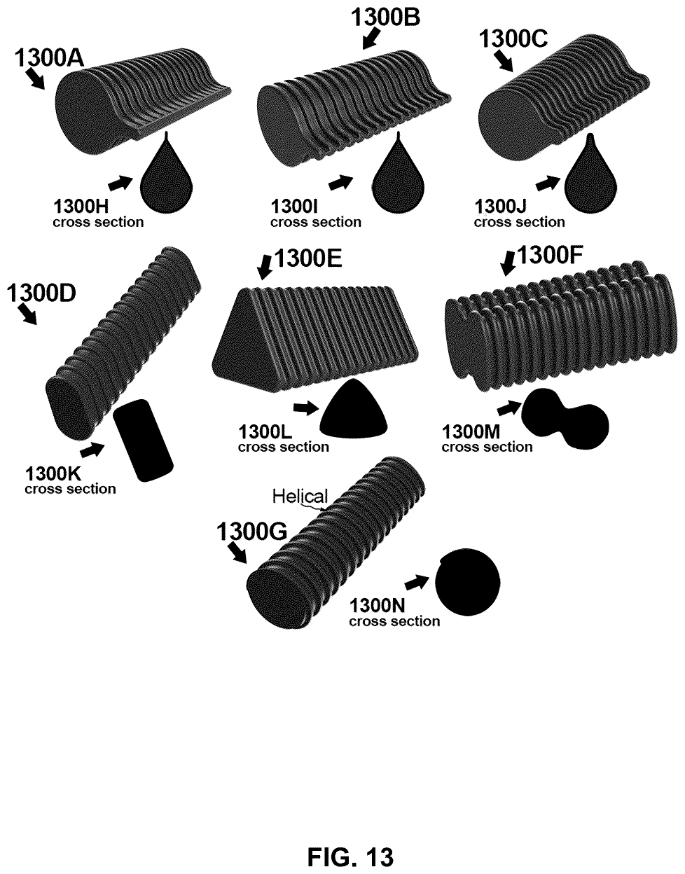

Refer to FIG. 13, nine separate pet chews according to embodiments of the present disclosure in a solid cylinder form with various cross-section shapes are illustrated therein. Each of pet chews 1300A/1300B/1300C/1300D/1300E/1300F has a series of alternating ridges and grooves running/extending latitudinally on the surface, and pet chew 1300G has a helical ridge extending from one end of the chew to the other looking like a screw thread. The cross-section shapes 1300H/1300I/1300J of pet chews 1300A/1300B/1300C resemble a water-drop icon, cross-section shape 1300K of Pet Chew 1300D does a rounded-rectangular shape, cross-section shape 1300L of Pet Chew 1300E does a rounded tri-angular shape, cross-section shape 1300M of Pet Chew 1300F does an Arabic “8” shape and cross-section shape 1300N of Pet Chew 1300G does a round shape.

### Method

In an aspect of the present disclosure, a method of preparing an edible pet chew is provided. The steps of the method include: A), preparing a composite material in accordance with any one of the formulas provided by the present disclosure; B), molding the composite material into a long corrugated sheet or ribbed sheet material (this molding process may be done by any method known in the art, such as by extrusion, roller forming, stamping forming and injection molding); C), cutting the long corrugated sheet or ribbed sheet material into numerous corrugated sheets or ribbed sheets in a pre-determined length; step E (optional), curving or rolling a corrugated sheet or a ribbed sheet into a final product shape. F), dehydrating or drying by heating treatment.

In another aspect of the present disclosure, a method of preparing an edible pet chew is provided. The steps of the method include: A), preparing and extruder and an extruder die with a Die Orifice in a shape of a wavy line or zigzag line; B), preparing a composite material in accordance with any one of the formulas provided by the present disclosure and feeding it into the extruder; C), a long corrugated sheet or ribbed sheet material is produced; D), cutting the long corrugated sheet or ribbed sheet material into numerous corrugated sheets or ribbed sheets in a pre-determined length; E), curving or rolling a corrugated sheet or a ribbed sheet along the directions of ridges and grooves on its surface into a final product shape. F), dehydrating or drying by heating treatment.

In another aspect of the present disclosure, a method of preparing an edible pet chew is provided. The steps of the method include: A), preparing an extruder and an extruder die with a Die Orifice in a shape of a wavy line in a spiral form, zigzag line in a spiral form, wavy line or zigzag line; B), preparing a composite material in accordance with any one of the formulas provided by the present disclosure and feeding it into the extruder; C), a long corrugated-sheet (or a long rolled corrugated-sheet) is thus produced; D), cutting the long corrugated sheet material (or long rolled corrugated-sheet) into numerous corrugated sheets (or rolled corrugated-sheet) in a pre-determined length; step E (optional), curving or rolling the corrugated sheet in a direction (approximately) perpendicular to the ridges and grooves on its surface into a final product shape; F), dehydrating or drying by heating treatment.

In another aspect of the present disclosure, a method of preparing an edible pet chew is provided. The steps of the method include: A), preparing an extruder and an extruder die with a long thin head; B), preparing a composite material in accordance with any one of the formulas provided by the present disclosure and feeding it into the extruder; C), positioning the long thin head of the extruder die into a corrugation forming equipment with a continuous chain of corrugation mould blocks; D), when the composite material leaves the extruder die, it is soft and moldable (it may be hot in a tube form); E), applying vacuum treatment or blowing treatment to have the composite material spread onto the internal surface of the corrugation mold blocks in order to create corrugation geometry to the material; F), the material cools down and a long corrugated tubular object is obtained; G), cutting a small piece in a pre-determined length from the long tubular object; H), dehydrating or drying by heating treatment.

In another aspect of the present disclosure, a method of preparing an edible pet chew is provided. The steps of the method include: A), preparing an extruder and an extruder die with a Die Orifice in a shape of a closed circle or closed curve; B), preparing a composite material in accordance with any one of the formulas provided by the present disclosure and feeding it into the extruder; C), a long tubular object is produced; D), putting the tubular object through a stamping forming process with a mold so as to form alternating ridges and grooves on its surface; E), cutting a small piece in a pre-determined length from the long tubular object; F), dehydrating or drying by heating treatment.

In another aspect of the present disclosure, a method of preparing an edible pet chew is provided. The steps of the method include: A), prepare a long flat sheet material (such as an extruded plant-based material sheet, an extruded animal ingredient-based material sheet, a rawhide sheet and a reconstituted-rawhide sheet); B), preparing a roller forming equipment, a roller gear forming equipment or a stramping forming equipment; C), feeding the long flat sheet material into the equipment; D), As it leaves the equipment, a very long corrugated sheet or ribbed sheet material is formed thereat; E), cutting the long corrugated sheet or ribbed sheet material into numerous corrugated sheets or ribbed sheets in a pre-determined length; F), curving or rolling a corrugated sheet or a ribbed sheet along the directions of ridges and grooves on its surface into a final product shape.

In another aspect of the present disclosure, a method of preparing an edible pet chew is provided. The steps of the method include: A), prepare a long flat sheet material (such as an extruded plant-based material sheet, an extruded animal ingredient-based material sheet, a rawhide sheet and a reconstituted-rawhide sheet); B), preparing a roller forming equipment, a roller gear forming equipment or a stramping forming equipment; C), feeding the long flat sheet material into the equipment; D), As it leaves the equipment, a very long corrugated sheet is formed thereat; E), cutting the long corrugated sheet material into numerous corrugated sheets in a pre-determined length; F), curving or rolling a corrugated sheet (approximately) in a direction perpendicular to the ridges and grooves on its surface into a final product shape.

In an aspect of the present disclosure, a method of preparing an edible pet chew is provided. The steps (injection molding process) of the method include: A), preparing an injection molding equipment and a metal mold in a desired cavity design and desired shape according to targeted product; B), preparing an edible thermoplastic composite material formulated as desired; C), having the material go down through a hopper, melted, fed through a heated chamber and forced through a plunger into the hollow metal mold; D), after the cavity has been filled, a holding pressure is continuously applied in this packing stage; E), the part cools and solidifies; F, the metal mold opens and the product is ejected from the mold.

In an embodiment of the present disclosure, a method of preparing an edible pet chew is provided. As illustrated in Process 0900A from FIG. 9, steps include: A), an Extruder Die 0901 with a Die Orifice 0902 in a shape like a wave is prepared to work with an extruder to make a Pet Chew 0904. B), Prepare a composite material (such as a thermoplastic plant-based composition material) and feed it to the extruder exposed to heat and pressure. C), As it leaves the extruder die, a very long ribbed sheet is formed thereat and cut a small piece in a pre-determined length, Ribbed-Sheet 0903, from it. D), Have Ribbed Sheet 0903 curved along the directions of ridges and grooves and rolled up into a tubular Pet Chew 0904. It is foreseen that a Corrugated Sheet 0903 rather than Ribbed Sheet 0903 may be alternatively generated by applying a different pre-designed extruder die resulting in a Pet Chew 0904 formed from a corrugated sheet material. It should be noted that, the aforementioned Step D may be replaced to make alternative products by a new one: D), Have Ribbed Sheet 0903 curved along the directions of ridges and grooves into a final product form of curved ribbed-sheet chew with a cross-section shape of an arc/curve, or final product form of an arc-shaped ribbed-sheet chip chew.

In an embodiment of the present disclosure, a method of preparing an edible pet chew is provided. As illustrated in Process 0900B from FIG. 9, an Extruder Die 0905 with a long thin Die Head 0906 is prepared to work with an extruder to make a Pet Chew 0908. Prepare a composite material (such as a thermoplastic animal ingredient-based composition material) and feed it to the extruder exposed to heat and pressure. As it leaves the long thin extruder Die Head 0906, soft and moldable, it spreads onto the internal surface of a running corrugation mold block chain in order to form a texture of alternating ridges and grooves on the surface to the material via vacuum treatment or blowing treatment. The material cools down and a very long tubular corrugated object is formed thereat. Cut a small piece in a pre-determined length from the long tubular corrugated object and have it dehydrated into a tubular Pet Chew 0908.

In an embodiment of the present disclosure, a method of preparing an edible pet chew is provided. As illustrated in Process 0900C from FIG. 9, prepare a long flat sheet material 0910 (such as an extruded plant-based material sheet, a rawhide sheet and a reconstituted-rawhide sheet) and have it fed to a Roller Forming Equipment 0909 with twin rolling rollers 0911. As it leaves the twin rollers 0911, a very long corrugated sheet material is formed thereat and cut a small piece in a pre-determined length, Corrugated Sheet 0912, from it. Have Corrugated Sheet 0912 curved along the directions of ridges and grooves and rolled up into a tubular Pet Chew 0913. It is foreseen that a Ribbed Sheet 0912 rather than Corrugated Sheet 0912 may be alternatively generated by applying a different pre-designed roller profile resulting in a Pet Chew 0913 formed from a ribbed sheet material. It should be noted that, after the Corrugated Sheet 0912 is ready from the aforementioned step, alternatively, Corrugated Sheet 0912 may be curved along the directions of ridges and grooves into a final product form of curved corrugated-sheet chew with a cross-section shape of an arc/curve or of an arc-shaped corrugated-sheet chip chew instead.

In an embodiment of the present disclosure, a method of preparing an edible pet chew is provided. As illustrated in Process 0900D from FIG. 9, prepare a long flat sheet material 0915 (such as a thermoplastic animal ingredient-based material sheet, a rawhide sheet and a reconstituted-rawhide sheet) and have it fed to a Roller (gear) Forming Equipment 0914 with twin rolling roller gears 0916. As it leaves the twin gears 0916, a very long ribbed sheet material is formed thereat and cut a small piece in a pre-determined length, Ribbed Sheet 0917, from it. Have Ribbed Sheet 0917 curved along the directions of ridges and grooves and rolled up into a tubular Pet Chew 0918. It is foreseen that a Corrugated Sheet 0917 rather than Ribbed Sheet 0917 may be alternatively generated by applying a different pre-designed gear profile resulting in a Pet Chew 0918 formed from a corrugated sheet material. It should be noted that, after the Ribbed Sheet 0917 is ready from the aforementioned step, alternatively, Ribbed Sheet 0917 may be curved along the directions of ridges and grooves into a final product form of curved ribbed-sheet chew with a cross-section shape of an arc/curve or of an arc-shaped ribbed-sheet chip chew instead.

In an embodiment of the present disclosure, a method of preparing an edible pet chew is provided. As illustrated in Process 1000E from FIG. 10, prepare a long flat sheet material 1002 (such as a thermoplastic plant-based material sheet, a rawhide sheet and a reconstituted-rawhide sheet) and have it fed to a Stamping Forming Equipment 1001 with stamping molds 1003. As it leaves the stamping molds 1003, a very long ribbed sheet is formed thereat and cut a small piece in a pre-determined length, Ribbed Sheet 1004, from it. Have Ribbed Sheet 1004 curved along the directions of ridges and grooves and rolled up into a tubular Pet Chew 1005. It is foreseen that a Corrugated Sheet 1004 rather than Ribbed Sheet 1004 may be alternatively generated by applying a different pre-designed stamping profile resulting in a Pet Chew 1005 formed from a corrugated sheet material. It should be noted that, after the Ribbed Sheet 1004 is ready from the aforementioned step, alternatively, Ribbed Sheet 1004 may be curved along the directions of ridges and grooves into a final product form of curved ribbed-sheet chew with a cross-section shape of an arc/curve or of an arc-shaped ribbed-sheet chip chew instead.

In an embodiment of the present disclosure, a method of preparing an edible pet chew is provided. As illustrated in Process 1000F from FIG. 10, an Injection Molding Equipment 1006 is prepared to make a Pet Chew 1010. The steps includes: A, prepare a metal Mold 1007 in a desired cavity shape according to a targeted product (such as a tubular pet chew with alternating latitudinal ridges and grooves, a rolled ribbed-sheet chew and an arc-shaped curved corrugated-sheet chip chew), either as a single cavity or multiple cavities; B, prepare an edible thermoplastic composite material, for example in a granule form (an exemplary composition to form the composite material may be a plant-based one including 20%-50% plant ingredient, 5%-20% humectant, 10%-30% animal ingredient, 1%-3% chicken cartilage and chemicals in the composition); C, the material goes down from a hopper 1008, melted, fed through a heated chamber 1009 and forced through a plunger into the hollow Mold 1007; D, after the cavity has been filled, a holding pressure is continuously applied in this packing stage and the melt material is compacted to increase the density of it; E, the part cools and solidifies; F, the Mold 1007 opens and the material is ejected from the Mold 1007; G, the material is dehydrated by for example drying into a final product 1010. It is foreseen that final product 1010 may be alternatively in any other desired forms (such as a rolled ribbed-sheet form, a rolled corrugated-sheet form, a curved ribbed-sheet form with a cross-section shape of an arc/curve, and a curved corrugated-sheet form with a cross-section shape of an arc/curve) provided by the present disclosure.

### Formula

The aforementioned pet chew component(s) to form the edible pet chew (such as the tubular component with alternating ridges and grooves, the corrugated-pipe-shaped tubular component, the trachea-shaped tubular component, the corrugated-pipe-shaped tubular component with a helical ridge and groove, the curved “corrugated sheet” or curved “ribbed sheet” component in a tube shape, the rolled “corrugated sheet” or rolled “ribbed sheet” component with latitudinal ridges and grooves in a cylinder shape or tube shape, the rolled “corrugated sheet” or rolled “ribbed sheet” component with longitudinal ridges and grooves in a cylinder shape or tube shape, the curved “corrugated sheet” or curved “ribbed sheet” component with a cross-section shape of an arc/curve) as provided in the present disclosure may be formed from a composite/composition material such as a plant-based material, an animal ingredient-based material and an animal hide-based material.

In an embodiment of the present disclosure, a composition (formula) of the plant-based material is provided including (by weight): 20%-80% plant material, 2%-40% humectants (more typically 10%-30% humectants; humectants such as glycerin, sorbitol). It may be free of animal hide material or free of rawhide. The composition may further include additives such as an attractant (such as dried brewer, hydrolyzed chicken liver), a colorant (such as titanium dioxide) and a preservative (such as potassium sorbate). The composition may further include a material serving as a natural source of glucosamine (chondroitin) such as trachea. The formula is a plant-based material one. In an embodiment, the composition (formula) is: Potato Starch (67.5%), Chicken breast (8%), Water (12%), Glycerin (11%) and Ground beef trachea (1.5%). In this formula, plant ingredients totally occupy 67.5% of the formula, meat by-products ingredient 1.5%, and meat 8%. Glycerin may serve as an additive or a chemical.

In an embodiment of the present disclosure, a composition (formula) of the animal ingredient-based material is provided including (by weight): 10%-50% animal ingredient(s), 30%-49.9% plant material, 2%-40% humectants (more typically 10%-30% humectants; humectants such as glycerin, sorbitol). The composition may be free of animal hide material or free of rawhide. The composition may further include additives such as an attractant (such as dried brewer, hydrolyzed chicken liver), a colorant (such as titanium dioxide) and a preservative (such as potassium sorbate). The composition may further include a synthetic Glucosamine/Chondroitin supplement or a Glucosamine/Chondroitin supplement substance obtained by extraction and/or chemical process (examples include glucosamine sulfate, glucosamine hydrochloride (HCL), N-acetyl-glucosamine or MSM glucosamine, glucosamine chondroitin, glucosamine chondroitin sulfate, glucosamine chondroitin MSM, chondroitin sulfate, chondroitin sulfate sodium and chondroitin hydrochloride). The formula is an animal ingredient-based material one. In an embodiment, the composition (formula) is: Frozen Chicken Breast (24%), Corn Starch (47.5%), Cattle Bone Powder (5%), beef liver (3%) and Glycerin (19%), Glucosamine Sulfate (1%) and Chondroitin Sulfate (0.5%). In this formula, animal ingredients totally occupy 32% (24%+5%+3%) of the formula, and plant ingredients 47.5%. Glycerin may serve as a humectant chemical. Glucosamine sulfate and Chondroitin may serve as chemicals or supplements.

It should be noted that, the humectant as used in the present disclosure may be selected from (but not limited to) the group consisting of: plant protein isolate, soy protein isolate, wheat protein isolate, corn protein isolate, glucose syrup, malt syrup, sodium pyrophosphate, trisodium orthophosphate, sodium hexametaphosphate, sodium tripolyphosphate, phosphoric acid, calcium dihydrogen phosphate, sodium lactate, maltitol, sorbitol, propylene glycol, glycerin, sodium dihydrogen phosphate, sodium phosphate dibasic, potassium lactate, sodium lactate, acetylated distarch phosphate, acetylated distarch adipate and any combination thereof.

In an embodiment of the present disclosure, a composition (formula) of the plant-based material is provided including (by weight on an as formulated basis): 50%-90% plant material, 2%-40% humectants (more typically 10%-30% humectants; humectants such as glycerin, sorbitol), 0.1%-20% animal ingredient (such as poultry digest, chicken liver, chicken meal, chicken breast powder, fish, bone powder). The composition may be free of animal hide material or free of rawhide. The composition may further include additives such as an attractant (such as dried brewer, hydrolyzed chicken liver), a colorant (such as titanium dioxide) and a preservative (such as potassium sorbate). The composition may further include a material serving as a natural source of glucosamine (chondroitin) such as trachea, chicken cartilage and crab shell. In an embodiment, the composition (formula) is: Tapioca (50%), Wheat starch (14%), Water (13%), Soybean protein (8%), Pork (5%), Ground Shark Cartilage (3%), Ground Crab Shell (2%), Sorbitol (3%) and Xanthan gum (2%). In this formula, plant ingredients totally occupy 72% (50%+14%+8%) of the formula, and animal ingredient 10% (5%+3%+2%). Sorbitol may serve as a humectant, and Xanthan gum, a chemical or additive.

In an embodiment of the present disclosure, a composition (formula) of the plant-based material is provided including (by weight): 15%-80% plant starch material, 2%-20% plant protein material, 2%-40% humectants (more typically 10%-30% humectants; humectants such as glycerin, sorbitol), 0.1%-30% animal ingredient (such as poultry digest, chicken liver, chicken meal, chicken breast powder, fish), 0.1%-8% attractant or flavor material (such as dried brewer yeast, hydrolyzed animal protein, chicken liver and hydrolyzed plant protein). The composition may be free of animal hide material or free of rawhide. The composition may further include additives such as an attractant (such as dried brewer, hydrolyzed chicken liver), a colorant (such as titanium dioxide) and a preservative (such as potassium sorbate). In an embodiment, the composition (formula) is: Sweet potato (52.7%), Potato starch (10%), Isolated pea protein (10%), Chicken breast powder (5%), Cattle liver powder (1%), Fructose (3%), Gelatin (2%), Bone powder (3%), Water (12%), Hydrolyzed chicken liver (1%), Sodium pyrophosphate (0.3%). In this formula, plant ingredients totally occupy 72.7% (52.7%+10%+10%) of the formula, and animal ingredient 9% (5%+1%+3%). Isolated pea protein may also work as a humectant as well as plant ingredient. Fructose and gelatin may serve as chemicals or additives. Hydrolyzed chicken liver may serve as an attractant.

In an embodiment of the present disclosure, a composition (formula) of the animal ingredient-based material is provided including (by weight): 10%-40% animal ingredient (such as poultry digest, chicken liver, chicken meal, chicken breast powder, fish, bone powder), 20%-49.9% plant material, 2%-40% humectants (more typically 10%-30% humectants; humectants such as glycerin, sorbitol). The composition may be free of animal hide material or free of rawhide. The composition may further include additives such as an attractant (such as dried brewer, hydrolyzed chicken liver), a colorant (such as titanium dioxide) and a preservative (such as potassium sorbate). The composition may further include a synthetic Glucosamine/Chondroitin supplement or a Glucosamine/Chondroitin supplement substance obtained by extraction and/or chemical process (examples include glucosamine sulfate, glucosamine hydrochloride (HCL), N-acetyl-glucosamine or MSM glucosamine, glucosamine chondroitin, glucosamine chondroitin sulfate, glucosamine chondroitin MSM, chondroitin sulfate, chondroitin sulfate sodium and chondroitin hydrochloride). The formula is an animal ingredient-based material one. In an embodiment, the composition (formula) is: Frozen chicken breast (36%), Potato (20%), Wheat starch (13%), Water (13%), Soybean protein (8%), Sorbitol (8%) and Xanthan gum (2%). In this formula, animal ingredients totally occupy 36% of the formula, and plant ingredients 41% (20%+13%+8%). Soybean protein may also work as a humectant as well as plant ingredient. Sorbitol works as a humectant. Xanthan gum may serve as a chemical or additive.

In an embodiment of the present disclosure, a composition (formula) of the plant ingredient-based material is provided including (by weight): Rice flour (67.2%, classified as plant ingredient), vegetable glycerin (8%), gelatin (7%), fresh chicken breast (5%, classified as meat ingredient or animal ingredient), ground bovine tendon (3%, classified as meat by-products ingredient or animal ingredient), cellulose powder (2%, classified as plant ingredient), calcium carbonate (2%), sweet potato (2%, classified as plant ingredient), lecithin (1%), carrageenan gum (1%), hydrolyzed pizzle (0.5% classified as meat by-products ingredient or animal ingredient), brewer's yeast (0.5%), titanium dioxide (0.4%), FD&C yellow 6 (0.2%), FD&C red 40 (0.1%), FD&C blue 1 (0.1%). In this formula, plant ingredient(s) totally occupy 71.2% (67.2%+2%+2%) of the formula, meat by-products ingredient 3.5%, and meat ingredient 5%. Vegetable glycerin may serve as a humectant chemical. Gelatin, calcium carbonate, carrageenan gum, titanium dioxide, FD&C yellow 6, FD&C red 40 and FD&C blue 1 may serve as some chemicals. Ground bovine tendon is applied as an animal ingredient naturally-glucosamine/chondroitin-rich.

In an embodiment of the present disclosure, a composition (formula) of the animal ingredient-based material is provided including (by weight): Rice flour (43.6%, classified as plant ingredient), fresh chicken breast (30%, classified as meat ingredient or animal ingredient), vegetable glycerin (8%), gelatin (7%), chicken cartilage (2%, classified as meat by-products ingredient or animal ingredient), cellulose powder (2%, classified as plant ingredient), calcium carbonate (2%), sweet potato (2%, classified as plant ingredient), lecithin (1%), carrageenan gum (1%), brewer's yeast (1%), titanium dioxide (0.4%). In this formula, animal ingredient(s) totally occupy 32% of the formula, and plant ingredient(s) 47.6% (less than 50%). Vegetable glycerin may serve as a humectant chemical. Gelatin, calcium carbonate, carrageenan gum and titanium dioxide may serve as some chemicals. Chicken cartilage is applied as an animal ingredient naturally-glucosamine/chondroitin-rich.

In an embodiment of the present disclosure, a composition (formula) of the animal ingredient-based material is provided including (by weight): Fresh chicken breast (28%, classified as meat ingredient or animal ingredient), tapioca starch (20%, classified as plant ingredient), ground shrimp shell (6%, classified as meat by-products ingredient or animal ingredient), ground bovine lung (4%, classified as meat by-products ingredient or animal ingredient), mussel meat (2%, classified as meat ingredient or animal ingredient), gelatin (12%), vegetable glycerin (8%), rawhide (5%, classified as animal hide ingredient), sorbitol (3.6%), cellulose powder (3%, classified as plant ingredient), calcium carbonate (3%), sweet potato (2%, classified as plant ingredient), lecithin (1%), carrageenan gum (0.7%), brewer's yeast (1%), titanium dioxide (0.4%), Glucosamine Sulfate (0.2%) and Chondroitin Sulfate (0.1%). In this formula, animal ingredient(s) totally occupy 40% of the formula, and plant ingredient(s) 25%. Vegetable glycerin and sorbitol may serve as humectant chemicals. Gelatin, calcium carbonate, lecithin, carrageenan gum and titanium dioxide may serve as some chemicals. Ground shrimp shell, ground bovine lung and mussel meat are applied as an animal ingredient naturally-glucosamine/chondroitin-rich.

In an embodiment of the present disclosure, a composition (formula) of the animal ingredient-based material is provided including (by weight): Cheese (20%), Whey protein powder (6%), Potato starch (22%), Pea starch (20%), Glycerin (15%), Sorbitol (7%), Gelatin (5%), Guar Gum (2%), Salt (1%), Xanthan Gum (1%), Citric acid (0.5%), Sodium citrate (0.3%), Potassium sorbate (0.1%), FD&C Yellow 6 (0.1%). In this formula, animal ingredient(s) totally occupy 26% of the formula (cheese 20%+whey protein powder 6%), and plant ingredient(s) 42% (22%+20%). Animal ingredients (26%) is larger than any other individual (or single) non-animal ingredient existing in the composition, such as potato starch or pea starch. Glycerin and sorbitol may serve as humectant chemicals. Gelatin, guar gum, salt, xanthan gum, citric acid, sodium citrate, potassium sorbate and FD&C yellow 6 may serve as some chemicals.

In an embodiment of the present disclosure, a composition (formula) of the animal hide-based material is provided including (by weight): Beef hide (20%), Pork hide (10%), Corn (25%), Rice (10%), Chicken breast (15%), Glycerin (9%), Sorbitol (2%), Peanut butter (2%, plant ingredient), Fructose (1%), Barley malt syrup (1%), Pork gelatin (2%), Salt (1%), Sodium Tripolyphosphate (0.5%), Potassium sorbate (preservative) (0.2%), Sodium pyrophosphate (0.2%), Xanthan gum (0.5%), Sodium propionate (preservative) (0.2%), Artificial flavoring (0.2%), FD&C Red 40 (0.1%), FD&C Blue 1 (0.05%), FD&C Yellow 6 (0.03%), FD&C yellow (0.02%). In this formula, animal hide ingredients totally occupy 30% (20%+10%) of the formula, and plant ingredients 37% (25%+10%+2%). Glycerin, sorbitol, sodium tripolyphosphate and sodium pyrophosphate may serve as humectants or chemicals. Fructose, barley malt syrup, pork gelatin, salt, potassium sorbate, xanthan gum, sodium propionate, the flavoring and the colorants may serve as chemicals or additives.

In an embodiment of the present disclosure, a composition (formula) of the animal ingredient-based material is provided including (by weight): 20%-80% frozen meat or dried meat powder, 10%-49.9% plant ingredient, 2%-40% humectants (more typically 10%-30% humectants; humectants such as glycerin, sorbitol). The composition may be free of animal hide material or free of rawhide. It may further include additives such as a colorant (such as FD&C Red 40) and a preservative (such as potassium sorbate). It may further include a material serving as a natural source of glucosamine (chondroitin) such as esophagus. In an embodiment, the composition (formula) is: Frozen Chicken breast (66%), Corn Starch (14%), Isolated soy protein (10%), Glycerin (8%) and ground beef esophagus (2%). In this formula, animal ingredients totally occupy 68% (66%+2%) of the formula, and plant ingredients 24% (14%+10%). Glycerin may serve as a humectant chemical.

In an embodiment of the present disclosure, a composition (formula) of the plant-based material is provided including (by weight on an as fed basis): 50%-80% plant material, 2%-40% humectants (more typically 10%-30% humectants; humectants such as glycerin, sorbitol), and attractant material (such as dried brewer, dried chicken breast powder, chicken digest, hydrolyzed chicken liver and artificial beef flavor). The composition may be free of animal hide material or free of rawhide. The composition may further include additives such as a colorant (such as FD&C Red 40) and a preservative (such as potassium sorbate). The composition may further include a material serving as a natural source of glucosamine (chondroitin) such as trachea, shark cartilage or shrimp shell. In an embodiment, the composition (formula) is: Corn Starch (58%), Chicken breast (15%), Hydrolyzed chicken liver (2%), Water (12%), Glycerin (9%) and beef tendon (4%). In this formula, plant ingredients totally occupy 58% of the formula, and animal ingredient 21% (15%+2%+4%). Glycerin may serve as a humectant chemical or additive.

In some embodiments of the present disclosure, a composition of one of aforementioned components of the edible pet chew is provided including at least 3% animal ingredient(s) by weight.

In some embodiments of the present disclosure, a composition of one of aforementioned components of the edible pet chew is provided including at least 3% meat by-products ingredient(s) by weight.

In some embodiments of the present disclosure, a composition of one of aforementioned components of the edible pet chew is provided including at least 3% (by weight) animal ingredient(s) that is naturally-Glucosamine/Chondroitin-rich. In some embodiments of the present disclosure, a composition of the aforementioned component of the edible pet chew is provided including at least 3% (by weight) animal Natural Part material (or animal natural organ material) that is naturally-Glucosamine/Chondroitin-rich. In some embodiments of the present disclosure, a composition of the aforementioned component of the edible pet chew is provided including at least 3% (by weight) animal ingredient(s) that is naturally-cartilage-rich. In some embodiments of the present disclosure, a composition of the aforementioned component of the edible pet chew is provided including at least 3% (by weight) animal Natural Part material (or natural organ material) that is naturally-cartilage-rich.

In some embodiments of the present disclosure, a composition of one of aforementioned components of the edible pet chew is provided including Glucosamine. In an embodiment of the present disclosure, a composition of one of aforementioned components of the edible pet chew is provided including at least 0.2% Glucosamine by weight. In some embodiments of the present disclosure, a composition of one of aforementioned components of the edible pet chew is provided including Chondroitin. In an embodiment of the present disclosure, a composition of one of aforementioned components of the edible pet chew is provided including at least 0.1% Chondroitin by weight. In some embodiments of the present disclosure, a composition of one of aforementioned components of the edible pet chew is provided including a naturally-Glucosamine/Chondroitin-rich animal material. In an embodiment of the present disclosure, a composition of one of aforementioned components of the edible pet chew is provided including at least 3% naturally-Glucosamine/Chondroitin-rich animal material by weight. In an embodiment of the present disclosure, a composition of one of aforementioned components of the edible pet chew is provided including at least 3% naturally-cartilage-rich animal material by weight. In an embodiment of the present disclosure, a composition of one of aforementioned components of the edible pet chew is provided including at least 3% animal cartilage material(s) by weight. In an embodiment of the present disclosure, a composition of one of aforementioned components of the edible pet chew is provided including at least 3% trachea and/or esophagus material by weight.

Yet some other aforementioned rawhide sheet tubular component(s) having a series of alternating ridges and grooves approximately parallel to each other running/extending (latitudinally) on the surface to form the edible pet chew as provided in the present disclosure may be formed from a material such as a traditional rawhide sheet, an animal hide sheet, a reconstituted-rawhide sheet and a reconstituted-animal hide sheet.

In an embodiment of the present disclosure, a composition (formula) of the rawhide sheet tubular component is provided including (by weight): Beef rawhide (100%).

In an embodiment of the present disclosure, a composition (formula) of the rawhide sheet tubular component is provided including (by weight): Porkhide (100%).

In yet another embodiment of the present disclosure, a composition (formula) of the rawhide sheet tubular component is provided including (by weight): animal hide and additives such as an attractant (such as dried brewer, hydrolyzed chicken liver), a colorant (such as caramel and FD&C yellow 6) and a preservative (such as potassium sorbate). The composition may further include a synthetic Glucosamine/Chondroitin supplement or a Glucosamine/Chondroitin supplement substance (as an additive) obtained by extraction and/or chemical process (examples include glucosamine sulfate, glucosamine hydrochloride (HCL), N-acetyl-glucosamine or MSM glucosamine, glucosamine chondroitin, glucosamine chondroitin sulfate, glucosamine chondroitin MSM, chondroitin sulfate, chondroitin sulfate sodium and chondroitin hydrochloride).

In an embodiment of the present disclosure, a composition (formula) of the rawhide sheet tubular component is provided including (by weight): Beef hide (98.5%), Added glucosamine sulfate chemical (1%) and Added chondroitin sulfate chemical (0.5%).

In yet another embodiment of the present disclosure, the rawhide sheet tubular component includes two portions, a rawhide sheet material portion and a coating material portion, in which a composition (formula) of the coating material portion is provided including (by weight): Maltodextrin (60%), Corn starch (30%), Chicken breast (8%), Caramel colorant (1%), Salt (0.8%) and Artificial chicken flavor (0.2%), and in which a composition (formula) of the rawhide sheet material portion is provided including (by weight): Reconstituted beef-rawhide (100%). In another embodiment of the present disclosure, a composition (formula) of the coating material portion is provided including (by weight): Maltodextrin (60%), Corn starch (23%), Ground chicken trachea (15%, serving as a naturally-Glucosamine/Chondroitin-rich material), Caramel colorant (1%), Salt (0.8%) and Artificial chicken flavor (0.2%), and in which a composition (formula) of the rawhide sheet material portion is provided including (by weight): Beef-rawhide (100%). In another embodiment of the present disclosure, a composition (formula) of the coating material portion is provided including (by weight): Maltodextrin (60%), Corn starch (30%), Glucosamine supplement (5%, serving as an added glucosamine chemical), Chondroitin supplement (3%, serving as an added chondroitin chemical), Caramel colorant (1%), Salt (0.8%) and Artificial chicken flavor (0.2%), and in which a composition (formula) of the rawhide sheet material portion is provided including (by weight): Beef-rawhide (100%).

One skilled in the art will understand that the embodiment of the present disclosure as shown in the drawings and described above is exemplary only and not intended to be limiting.

What is claimed is:

1. An edible pet chew, comprising:
a tubular component, wherein said tubular component comprises any one of:
a series of alternating ridges and grooves approximately parallel to each other running on a surface of the tubular component, and
a helical ridge running on a surface of the tubular component.

2. The edible pet chew of claim 1, wherein said tubular component comprises the series of alternating ridges and grooves, wherein each of said ridges runs approximately latitudinally on the surface, wherein each of said grooves runs approximately latitudinally on the surface, and wherein said helical ridge extends helically like a screw thread on the surface.

3. The edible pet chew of claim 2, wherein
a cross-section outline shape of said tubular component is any one of: a closed curve, a closed circle, an open curve, and an open circle, and
wherein said ridges are in any one of: a closed curve shape, an open curve shape, an O-shape and a C-shape.

4. The edible pet chew of claim 2, wherein
said tubular component is a corrugated-pipe-shaped component or a trachea-chew-shaped component, and wherein said tubular component imitates any one of:
a shape of a Corrugated Pipe or a Trachea chew,
a profile of a Corrugated Pipe or a Trachea chew,
a structure of a Corrugated Pipe or a Trachea chew,
a form of a Corrugated Pipe or a Trachea chew,
an appearance of a Corrugated Pipe or a Trachea chew, and
a texture of a Corrugated Pipe or a Trachea chew.

5. The edible pet chew of claim 3, wherein
said cross-section outline shape is selected from the group consisting of: a circle, a water-drop icon, a rounded-triangle, a rounded-rectangle, a polygon, an Arabic “8,” an Arabic “9” in the font of “Tw Cen MT”, a comma of punctuation mark, an irregular closed-curve shape, and an irregular open-curve shape.

6. The edible pet chew of claim 1, wherein
said tubular component is formed from a composite material, and wherein said composite material is any one of: a plant-based material, an animal ingredient-based material, and an animal hide-based material.

7. The edible pet chew of claim 6, wherein
said plant-based material comprises a plant ingredient selected from the group consisting of: potato, sweet potato, mung bean, wheat, corn, tapioca, rice, pea, soybean, peanut, almond, mushroom, legumes, beans, grains, chia seed, algae, seaweed, spirulina, cereals, a material of plant edible part, a plant derived material, a plant protein, a plant starch, a plant fiber, a vegetable material, a vegetable derived material, a vegetable protein, a vegetable starch, and any combination thereof, and wherein
said animal ingredient-based material comprises an animal ingredient selected from the group consisting of meat, meat by-products, and any combination thereof, and wherein said meat by-products is a material selected from the group consisting of: lungs, spleen, kidneys, brain, livers, blood, bone, partially defatted low-temperature fatty tissue, stomachs, intestines, milk, milk powder, milk-derived material, cheese, cheese-derived material, whey, whey protein powder, whey-derived material, egg, egg-derived material, and any combination thereof.

8. The edible pet chew of claim 6, wherein
said plant-based material comprises substantially at least 20% plant ingredient by weight, wherein
said animal ingredient-based material comprises substantially at least 10% animal ingredient and 5%-49.9% plant ingredient by weight, and wherein
said animal hide-based material comprises substantially at least 20% animal hide ingredient and 0.1%-49.9% plant ingredient by weight.

9. The edible pet chew of claim 1, wherein
said tubular component is formed from a material selected from the group consisting of: a rawhide sheet, an animal hide sheet, a reconstituted rawhide sheet, a reconstituted animal hide sheet, a plant-based composite material, an animal ingredient-based composite material, and an animal hide-based composite material.

10. The edible pet chew of claim 2, wherein
said tubular component is formed from a material selected from the group consisting of: a rawhide sheet, an animal hide sheet, a reconstituted rawhide sheet and a reconstituted animal hide sheet, and wherein
a glucosamine substance or chondroitin substance is introduced into said rawhide sheet, said animal hide sheet, said reconstituted rawhide sheet and said reconstituted animal hide sheet by a process selected from the group consisting of: a soaking process with a material in a solution or paste form, a basting process with a basting material and a coating process with a coating material.

11. The edible pet chew of claim 1, wherein
said tubular component is rawhide free or animal hide free.

12. The edible pet chew of claim 1, wherein
said edible pet chew comprises a substance in the chew selected from the group consisting of: a trachea material, an esophagus material, a cartilage material, a naturally cartilage-rich material, a naturally glucosamine-rich material, a naturally chondroitin-rich material, a synthetic glucosamine, a synthetic chondroitin, a glucosamine supplement material, a chondroitin supplement material, a glucosamine compound, a chondroitin compound, a glucosamine sulfate, a chondroitin sulfate, a glucosamine hydrochloride, a chondroitin hydrochloride, and any combination thereof.

13. The edible pet chew of claim 12, wherein
said edible pet chew comprises a substance in the chew selected from the group consisting of: at least 3% trachea material, at least 3% esophagus material, at least 3% cartilage material, at least 3% naturally cartilage-rich material, at least 3% naturally glucosamine-rich material, at least 3% naturally chondroitin-rich material, at least 0.2% synthetic glucosamine, at least 0.1% synthetic chondroitin, at least 0.2% glucosamine supplement material, at least 0.1% chondroitin supplement material, at least 0.2% glucosamine compound, at least 0.1% chondroitin compound, at least 0.2% glucosamine sulfate, at least 0.1% chondroitin sulfate, at least 0.2% glucosamine hydrochloride, at least 0.1% chondroitin hydrochloride, and any combination thereof.

14. The edible pet chew of claim 2, wherein
said tubular component comprises in the formula a substance selected from the group consisting of: a trachea material, an esophagus material, a cartilage material, a naturally cartilage-rich material, a naturally glucosamine-rich material, a naturally chondroitin-rich material, a synthetic glucosamine, a synthetic chondroitin, a glucosamine supplement material, a chondroitin supplement material, a glucosamine compound, a chondroitin compound, a glucosamine sulfate, a chondroitin sulfate, a glucosamine hydrochloride, a chondroitin hydrochloride, and any combination thereof.

15. The edible pet chew of claim 14, wherein
said naturally glucosamine-rich material is a one selected from the group consisting of: animal cartilage, animal trachea, animal esophagus, shellfish shells, fungus, mushroom, animal tendon, poultry foot, mussel meat, animal lung, animal bone, animal bone marrow, animal tail, animal ear, eggshell membrane, and any combination thereof, wherein
said naturally chondroitin-rich material is selected from the group consisting of: animal cartilage, animal trachea, animal esophagus, shellfish shells, fungus, mushroom, animal tendon, poultry foot, mussel meat, animal lung, animal bone, animal bone marrow, animal tail, animal ear, eggshell membrane, and any combination thereof, wherein
said glucosamine compound is selected from the group consisting of: glucosamine sulfate, glucosamine hydrochloride (HCL), N-acetyl-glucosamine or MSM glucosamine, glucosamine chondroitin, glucosamine chondroitin sulfate, glucosamine chondroitin MSM, and any combination thereof, and wherein
said chondroitin compound is selected from the group consisting of: glucosamine chondroitin, glucosamine chondroitin sulfate, glucosamine chondroitin MSM, chondroitin sulfate, chondroitin sulfate sodium, chondroitin hydrochloride, and any combination thereof.

16. The edible pet chew of claim 9, wherein
said tubular component is formed from a corrugated sheet material or a ribbed sheet material, wherein said corrugated sheet material is curved or rolled to form a tube shape, and wherein said ribbed sheet material is curved or rolled to form a tube shape.

17. The edible pet chew of claim 1, wherein
said tubular component is formed from a corrugated sheet material or a ribbed sheet material, wherein said corrugated sheet material is rolled up to form a cylinder-shaped chew component by wrapping many times, and wherein said ribbed sheet material is rolled up to form a cylinder-shaped chew component by wrapping many times.

18. The edible pet chew of claim 2, wherein
said tubular component is manipulated into a final product shape selected from the group consisting of: twisted tube, knotted bone, tube ring, braids, pretzel, dumbbell, kabob, and spiral.

19. The edible pet chew of claim 1, further comprising:
a second edible material component, wherein said tubular component serves as a first tubular component, and wherein said first tubular component and said second edible material component are assembled together in a pre-determined relationship to form a final product.

20. The edible pet chew of claim 19, wherein
said second edible material component is a porous material component formed from a plant-based material or a naturally glucosamine-rich material component, wherein at least a portion of said porous material component is wrapped in said tubular component without exposure, and wherein at least of portion of said naturally glucosamine-rich material component is wrapped in said tubular component without exposure.

21. The edible pet chew of claim 2, further comprising:
a coating material or a basting material, wherein said coating material or said basting material spreads or is sprayed onto a part of the surface of a ridge of said tubular component.

22. The edible pet chew of claim 1, wherein
said series of alternating ridges and grooves approximately parallel to each other run approximately longitudinally on the surface, wherein said tubular component is formed from a corrugated sheet material, and wherein said corrugated sheet material is formed from a material selected from the group consisting of: a composite material, a plant-based composite material, an animal ingredient-based composite material, an animal hide-based composite material, a rawhide sheet, an animal hide sheet, a reconstituted rawhide sheet, and a reconstituted animal hide sheet.

23. The edible pet chew of claim 22, further comprising:
a second component, wherein said second component is a tube material, wherein said tubular component serves as a first component, and wherein said first component and said second component are assembled together in a pre-determined relationship to form a final product.

24. The edible pet chew of claim 1, wherein
said tubular component is divided into plural curved corrugated sheet pieces or plural curved ribbed sheet pieces, wherein each of said curved corrugated sheet pieces has alternating ridges and grooves approximately parallel to each other running latitudinally on the surface, wherein a cross-section shape of said curved corrugated sheet piece is a curve or an arc, wherein each of said plural curved ribbed sheet pieces has alternating ridges and grooves approximately parallel to each other running latitudinally on the surface, and wherein a cross-section shape of said curved ribbed sheet piece is a curve or an arc.

25. An edible pet chew, comprising:
a cylindrical component having any one of: a series of alternating ridges and grooves running on a surface of said cylindrical component approximately parallel to each other and a helical ridge running helically on the surface, wherein said series of alternating ridges and grooves run approximately latitudinally on the surface, wherein each of said ridges runs approximately latitudinally on the surface, wherein each of said grooves runs approximately latitudinally on the surface, wherein said cylindrical component is formed from a corrugated sheet material or a ribbed sheet material, wherein said corrugated sheet material is rolled up to form a cylindrical shape, and wherein said ribbed sheet material is rolled up to form a cylindrical shape.

26. A method of making an edible pet chew, comprising:
a. providing an edible thermoplastic composite material;
b. providing an extruder with an extruder die and a corrugation forming equipment with a continuous chain of corrugation mold blocks;
c. extruding the thermoplastic composite material by the extruder so as to provide a soft and moldable composite material when it leaves the extruder die; and
d. having the soft and moldable composite material exposed to a vacuum treatment or a blowing treatment so as to have the soft and moldable composite material spread onto an internal surface of the corrugation mold blocks.
